(19) United States
(12) Patent Application Publication
(10) Pub. No.: US 2026/0227181 A1
(43) Pub. Date: Aug. 6, 2026

(54) 3D SCANNER INCLUDING A SET OF PROJECTORS PROJECTING AN INTERLEAVED PATTERN

(71) Applicant: CREAFORM INC., Lévis (CA)

(72) Inventors: Sébastien Bouchard, Québec (CA); Francis Cayer, St-Eustache (CA); Antoine Thomas Caron, Québec (CA); Guylain Lemelin, Québec (CA); Jean-Nicolas Ouellet, Saint-Augustin-de-Desmaures (CA); Éric Saint-Pierre, Lévis (CA)

(73) Assignee: CREAFORM INC., Lévis, QC (CA)

(21) Appl. No.: 19/152,033

(22) PCT Filed: Jun. 17, 2024
(86) PCT No.: PCT/CA2024/050817

§ 371 Date: Jul. 30, 2025

Related U.S. Application Data
(60) Provisional application No. 63/509,410, filed on Jun. 21, 2023.

(51) Int. Cl. G01B 11/25

(52) U.S. Cl. CPC G01B 11/2513; G01B 11/2518; G01B 11/254

(57) ABSTRACT

A three-dimensional (3D) scanner for projecting an interleaved pattern is provided, the 3D scanner comprising a set of projectors and at least one camera. The set of projectors comprise: a first projector for projecting a first multiline pattern onto a surface of a target object; and a second projector for projecting a second multiline pattern onto the surface concurrently with the first multiline pattern to generate the interleaved pattern. The second projector is positioned relative to the first projector such that: a light line of the first multiline pattern is projected onto the surface between two light lines of the second multiline pattern; and a light plane projected by the first projector defining the light line of the first multiline pattern and two light planes projected by the second projector defining the two light lines of the second multiline pattern is non-intersecting throughout a DOF of the 3D scanner.

### CROSS-REFERENCE TO RELATED APPLICATION

This application claims the benefit of U.S. provisional application No. 63/509,410 filed Jun. 21, 2023, which is incorporated by reference herein in its entirety.

### TECHNICAL FIELD

The present disclosure generally relates to the field of measuring devices and methods, and, more particularly, to systems and methods for projecting an interleaved pattern utilizing a set of projectors including two or more projectors.

### BACKGROUND

Transportable measuring systems such as handheld three-dimensional (3D) scanners are used for generating 3D measurements of a surface of a target object and generating 3D representations (such as 3D point clouds and/or 3D meshes) of such surfaces. For example, conventional handheld scanners comprise imaging modules such as at least two cameras rigidly fixed with respect to each other (e.g., a “stereo camera” configuration) which may be used to capture frames of surfaces. Scanning of the surfaces can be achieved by moving the handheld 3D scanner to several different poses having corresponding different viewpoints of the target object and capturing a portion of the surface of the object at each viewpoint with the images modules. Frames of the surface of the target object from different viewpoints may then be analyzed to extract 3D measurements therefrom and may then be combined using various techniques (including triangulation, bundle adjustment and other pose graph optimization techniques) in order to create a 3D representation of the object.

An important challenge in a stereo camera 3D measurement is how to accurately match features of images obtained from the two different viewpoints (e.g., two different cameras). An approach for simplifying feature matching between images includes the use of a light projector that projects a plurality of light planes (or any other type of light elements) oriented in a known configuration towards the target object being scanned. The projected light planes resolve as a corresponding two-dimensional (2D) plurality of light lines (or any other type of corresponding 2D light element) on the surface of the target object. The frames captured by the at least two cameras include representations of the light lines projected by the light projector. By leveraging known orientation and origin of the projected light planes, in combination with a known baseline distance and a known orientation of the two different viewpoints, features belonging to a same light stripe can be more accurately matched between different images and the corresponding relative position of an observed point can be more accurately derived. Generally, increasing a number and/or density of light lines projected onto the surface of the target object can increase a scanning speed and/or scanning accuracy.

To manufacture 3D scanners capable of scanning larger objects, it may be desirable to increase an overall field of view (FOV) and/or depth of field (DOF) of the 3D scanner. The larger overall FOV and/or DOF of the 3D scanner may allow the 3D scanner to be positioned further away from the surface of the target object, and thus to scan larger target objects. However, the light projector associated with 3D scanners is often implemented as a “multiline projector” which projects the plurality of light planes from a single projector origin, but with an inter-beam angle separating two light planes. With such multiline projectors, as the surface being scanned is positioned further away from the projector origin, a distance between two adjacent light lines resolving on the surface increases and an overall density of light lines resolving on the surface decreases. This reduction in the number and/or density of light lines can reduce scanning speed and/or scanning accuracy.

To counter this issue with increased distance between resolved light lines, possible solutions include decreasing a field-of-projection (FOP) of the scanner (resulting in a same number, but increased density, of light lines) and/or increasing a number of light planes projected by the projector (resulting in both increasing number and density of light lines). However, decreasing the FOP of the light projector may be counterproductive for scanning larger target objects, as more frames may need to be captured which can also reduce scanning speed. Simply increasing a number of light planes projected by the light projector over a same FOP may require a corresponding increase in power of a light source associated with the light projector in order to achieve sufficiently bright light lines on the surface for a 3D scanning procedure. However, increasing the power of the light source may cause the projector to exceed certain laser eye-safety standards and require an operator to use protective eye equipment when operating a 3D scanner incorporating such a projector.

Against the background described above, there remains a need in the industry to provide improved handheld 3D scanners that alleviate at least some of the deficiencies noted above.

### SUMMARY

This summary is provided to introduce a selection of concepts in a simplified form that are further described below in the Detailed Description. This Summary is not intended to identify all key aspects and/or essential aspects of the claimed subject matter.

In one embodiment, there is provided a three-dimensional (3D) scanner for projecting an interleaved pattern, the 3D scanner comprising a set of projectors and at least one camera. The set of projectors comprise: a. a first projector for projecting a first multiline pattern onto a surface of a target object; and b. a second projector for projecting a second multiline pattern onto the surface concurrently with the first multiline pattern to generate the interleaved pattern. The second projector is positioned relative to the first projector such that: i. a light line of the first multiline pattern is projected onto the surface between two light lines of the second multiline pattern; and ii. a light plane projected by the first projector defining the light line of the first multiline pattern and two light planes projected by the second projector defining the two light lines of the second multiline pattern is non-intersecting throughout a depth of field (DOF) of the 3D scanner.

The first projector and the second projector may be mounted to the 3D scanner such that each light plane projected by the first projector and each light plane projected by the second projector may be non-intersecting throughout the DOF of the 3D scanner.

The first projector and the second projector may be mounted to the 3D scanner such that a first origin of the first projector and a second origin of the second projector may be offset by a projector offset angle.

The projector offset angle may be a function of at least one of: a number of projectors in the set of projectors, a first inter-beam angle between light planes projected by the first projector or a second inter-beam angle between light planes projected by the second projector.

The first inter-beam angle and the second inter-beam angle may be substantially the same. The projector offset angle may be approximately ½ of the first and second inter-beam angles.

The first inter-beam angle and the second inter-beam angle may be different.

The light line of the first multiline pattern may be projected onto the surface immediately adjacent the two light lines of the second multiline pattern.

More than one light line of the first multiline pattern may be projected onto the surface between the two light lines of the second multiline pattern. The light line of the first multiline pattern may be projected onto the surface immediately adjacent one light line of the first multiline pattern and one light line of the second multiline pattern.

The set of projectors may further comprise a third projector for projecting a third multiline pattern onto the surface concurrently with the first multiline pattern and the second multiline pattern to generate the interleaved pattern.

The first projector, the second projector and the third projector may be mounted to the 3D scanner such that a first origin of the first projector and a second origin of the second projector may be offset by a first projector offset angle and a third origin of the third projector and the second origin is offset by a second projector angle.

The first and second projector offset angles may be functions of at least one of: a number of projectors in the set of projectors, a first inter-beam angle between light planes projected by the first projector, a second inter-beam angle between light planes projected by the second projector, or a third inter-beam angle between light planes projected by the third projector.

The first inter-beam angle, the second inter-beam angle and the third inter-beam angle may be substantially the same. The first and second projector offset angles may be both approximately ⅓ of the first, second and third inter-beam angles.

The first inter-beam angle, the second inter-beam angle and the third inter-beam angle may be different.

The set of projectors may further comprise at least one further projector for projecting at least one further multiline pattern onto the surface concurrently with the first multiline pattern and the second multiline pattern.

The at least one further projector may be mounted to the 3D scanner such that at least one origin of the at least one further projector may be offset by a projector offset angle relative to at least one of a first origin of the first projector and a second origin of the second projector. The projector offset angle may be a function of at least one of: a number of projectors in the set of projectors or inter-beam angles of light planes projected by the projectors in the set of projectors.

The set of projectors may comprise a top set of projectors, the first projector may comprise a first top projector, the second projector may comprise a second top projector, and the interleaved pattern may comprise a first interleaved pattern. The 3D scanner may further comprise a bottom set of projectors. The bottom set of projectors may comprise: a. a first bottom projector for projecting a third multiline pattern onto the surface at a different time point than projection of the first multiline pattern by the first top projector and projection of the second multiline pattern by the second top projector; and b. a second bottom projector for projecting a fourth multiline pattern onto the surface concurrently with the third multiline pattern to generate a second interleaved pattern.

The top set of projectors may be mounted to the 3D scanner such that a top baseline of the top set of projectors may be at a top set angle relative to a scanner plane of the 3D scanner and the bottom set of projectors may be mounted to the 3D scanner such that a bottom baseline of the bottom set of projectors may be at a bottom set angle relative to the scanner plane.

The top set angle may be approximately +30°, and the bottom set angle is approximately −30°.

The at least one camera may be for capturing at least one image including a representation of the interleaved pattern or a portion thereof reflected from the surface when the first and second projector projects the first and second multiline patterns concurrently onto the surface.

The scanner may further comprise at least one processor circuit for processing the at least one image and to generate 3D measurements for the surface based at least in part on the representation of the interleaved pattern or the portion thereof reflected from the surface.

In another embodiment, there is provided a method of projecting an interleaved pattern with a three-dimensional (3D) scanner having a set of projectors and at least one camera. The method comprises: a. projecting, with a first projector of the set of projectors, a first multiline pattern onto a surface of a target object; and b. projecting, with a second projector of the set of projectors, a second multiline pattern onto the surface concurrently with the first multiline pattern to generate the interleaved pattern. The second projector is positioned relative to the first projector such that: i. a light line of the first multiline pattern is projected onto the surface between two light lines of the second multiline pattern; and ii. a light plane projected by the first projector defining the light line of the first multiline pattern and two light planes projected by the second projector defining the two light lines of the second multiline pattern is non-intersecting throughout a depth of field (DOF) of the 3D scanner.

The first projector and the second projector may be mounted to the 3D scanner such that each light plane projected by the first projector and each light plane projected by the second projector may be non-intersecting throughout the DOF of the 3D scanner.

The first projector and the second projector may be mounted to the 3D scanner such that a first origin of the first projector and a second origin of the second projector may be offset by a projector offset angle.

The projector offset angle may be a function of at least one of: a number of projectors in the set of projectors, a first inter-beam angle between light planes projected by the first projector or a second inter-beam angle between light planes projected by the second projector.

The first inter-beam angle and the second inter-beam angle may be substantially the same. The projector offset angle may be approximately ½ of the first and second inter-beam angles.

The first inter-beam angle and the second inter-beam angle may be different.

The second projector may be positioned relative to the first projector such that the light line of the first multiline pattern may be projected onto the surface immediately adjacent the two light lines of the second multiline pattern.

The second projector may be positioned relative to the first projector such that more than one light line of the first multiline pattern may be projected onto the surface between the two light lines of the second multiline pattern. The light line of the first multiline pattern may be projected onto the surface immediately adjacent one light line of the first multiline pattern and one light line of the second multiline pattern.

The method may further comprise projecting, with a third projector of the set of projectors, a third multiline pattern onto the surface concurrently with the first multiline pattern and the second multiline pattern to generate the interleaved pattern.

The first projector, the second projector and the third projector may be mounted to the 3D scanner such that a first origin of the first projector and a second origin of the second projector may be offset by a first projector offset angle and a third origin of the third projector and the second origin is offset by a second projector angle.

The first and second projector offset angles may be functions of at least one of: a number of projectors in the set of projectors, a first inter-beam angle between light planes projected by the first projector, a second inter-beam angle between light planes projected by the second projector, or a third inter-beam angle between light planes projected by the third projector.

The first inter-beam angle, the second inter-beam angle and the third inter-beam angle may be substantially the same. The first and second projector offset angles may be both approximately ⅓ of the first, second and third inter-beam angles.

The first inter-beam angle, the second inter-beam angle and the third inter-beam angle may be different.

The set of projectors may further comprise at least one further projector for projecting at least one further multiline pattern onto the surface concurrently with the first multiline pattern and the second multiline pattern.

The at least one further projector may be mounted to the 3D scanner such that at least one origin of the at least one further projector may be offset by a projector offset angle relative to at least one of a second origin of the second projector and a first origin of the first projector. The projector offset angle may be a function of at least one of: a number of projectors in the set of projectors or inter-beam angles of light planes projected by the projectors in the set of projectors.

The set of projectors may comprise a top set of projectors, the first projector may comprise a first top projector, the second projector may comprise a second top projector, the interleaved pattern may comprise a first interleaved pattern, the 3D scanner may further comprise a bottom set of projectors. The method may further comprise: a. projecting, with a first bottom projector of the bottom set of projectors, a third multiline pattern onto the surface at a different time point than projection of the first multiline pattern by the first top projector and projection of the second multiline pattern by the second top projector; and b. projecting, with a second bottom projector of the bottom set of projectors, a fourth multiline pattern onto the surface concurrently with the third multiline pattern to generate a second interleaved pattern.

The top set of projectors may be mounted to the 3D scanner such that a top baseline of the top set of projectors may be at a top set angle relative to a scanner plane of the 3D scanner and the bottom set of projectors may be mounted to the 3D scanner such that a bottom baseline of the bottom set of projectors may be at a bottom set angle relative to the scanner plane.

The top set angle may be approximately +30°, and the bottom set angle is approximately −30°.

All features of exemplary embodiments which are described in this disclosure and are not mutually exclusive can be combined with one another. Elements of one embodiment or aspect can be utilized in the other embodiments/aspects without further mention. These and other aspects of this disclosure will now become apparent to those of ordinary skill in the art upon review of a description of embodiments that follows in conjunction with accompanying drawings.

### BRIEF DESCRIPTION OF DRAWINGS

The features of the present disclosure will become more apparent with reference to the following description taken in conjunction with the accompanying drawings, wherein like reference numerals denote like elements and in which:

FIG. 1 is a schematic of a three-dimensional (3D) scanner in accordance with one disclose embodiment;

FIG. 2 is a schematic of a set of cameras and a set of projectors of the 3D scanner of FIG. 1 in accordance with one embodiment;

FIGS. 3A and 3B are a schematic of a depth of field (DOF) and a height and a width of a field of view (FOV) of the 3D scanner of FIG. 1 in accordance with one embodiment as compared to another 3D scanner;

FIG. 4 is a schematic of an assessment aperture for assessing an eye safety class of the 3D scanner of FIG. 1 in accordance with one embodiment;

FIG. 5 is a horizontal elevation view of the set of projectors of the 3D scanner of FIG. 1 in accordance with one embodiment;

FIG. 6 is a schematic view of the set of projectors of FIG. 5 viewed along line 6-6 in FIG. 5 in accordance with one embodiment;

FIG. 7 is a schematic view of the set of projectors of FIG. 6 in accordance with one embodiment;

FIGS. 8A-8C are representations of a first multiline pattern, a second multiline pattern and an interleaved pattern projected by the set of projectors of FIG. 6 in accordance with one embodiment;

FIGS. 9A-9C are representations of a first multiline pattern, a second multiline pattern and an interleaved pattern projected by the set of projectors of FIG. 6 in accordance with another embodiment;

FIGS. 10A-10C are representations of a first multiline pattern, a second multiline pattern and an interleaved pattern projected by the set of projectors of FIG. 6 in accordance with another embodiment;

FIGS. 11A-11C are representations of a first multiline pattern, a second multiline pattern and an interleaved pattern projected by the set of projectors of FIG. 6 in accordance with another embodiment;

FIGS. 12A-12C are representations of a first multiline pattern, a second multiline pattern and an interleaved pattern projected by the set of projectors of FIG. 5 in accordance with another embodiment;

FIG. 13 is a horizontal elevation view of the set of projectors of the 3D scanner of FIG. 1 in accordance with another embodiment;

FIG. 14 is a schematic view of the set of projectors of the 3D scanner of FIG. 13 viewed along line 14-14 in FIG. 13 in accordance with one embodiment;

FIG. 15 is a schematic view of the set of projectors of FIG. 13 in accordance with one embodiment;

FIGS. 16A-16D are representations of a first multiline pattern, a second multiline pattern, a third multiline pattern and an interleaved pattern projected by the set of projectors of FIG. 13 in accordance with one embodiment;

FIG. 17 is a schematic view of the set of projectors of FIG. 5 viewed along line 6-6 in FIG. 5 in accordance with another embodiment;

FIG. 18 is a schematic view of the set of projectors of FIG. 17 in accordance with one embodiment;

FIG. 19 is a schematic view of a set of projectors of the 3D scanner of FIG. 1 in accordance with another embodiment; and

FIG. 20 is representations of a first interleaved pattern and a second interleaved pattern projected by, respectively, a top set of projectors and a bottom set of projectors of the 3D scanner of FIG. 1 in accordance with one embodiment.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION

A detailed description of one or more specific embodiments of the invention is provided below along with accompanying Figures that illustrate principles of the invention. The invention is described in connection with such embodiments, but the invention is not limited to any specific embodiment. In particular, the present detailed description presents, amongst other, some embodiments in which a three-dimensional (3D) scanner includes a set of projectors including a first projector for projecting a first multiline pattern onto a surface of a target object and a second projector for projecting a second multiline pattern onto the surface concurrently with the first multiline pattern to generate an interleaved pattern. In the interleaved pattern, a light line of the first multiline pattern is projected onto the surface between two light lines of the second multiline pattern. Further, the second projector may be positioned relative to the first projector such that a light plane projected by the first projector defining the light line of the first multiline pattern and two light planes projected by the second projector defining the two light lines of the second multiline pattern is non-intersecting throughout a depth of field (DOF) of the 3D scanner. This can allow a first projector origin of the first projector and a second projector origin of the second projector to be seen as disparate/extended origins by a typical human eye as assessed at an assessment aperture (described below) corresponding to the typical human eye. Use of disparate/extended origins can increase a factor C₆ used to assess eye safety of the 3D scanner, and the increase in the factor C₆ allows for a corresponding an increase an allowable accessible emission produced by the first and second projectors at the assessment aperture.

It is to be appreciated that the embodiments described are being provided only for the purpose of illustrating the inventive principles and should not be considered as limiting. In particular, alternate embodiments will become apparent to those skilled in the art in view of the present description. Numerous specific details are set forth in the following description in order to provide a thorough understanding of the invention. These details are provided for the purpose of describing non-limiting examples and the invention may be practiced without some or all of these specific details. For the purpose of clarity, technical material that is known in the technical fields related to the invention has not been described in great detail so that the invention is not unnecessarily obscured.

### Scanner 100

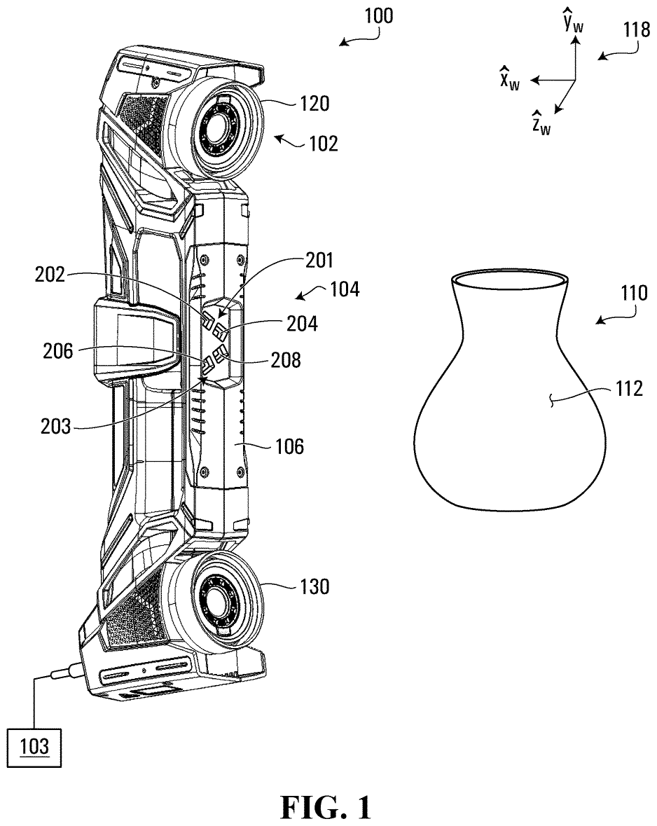

Referring to FIG. 1, a three-dimensional (3D) scanner in accordance with one embodiment is generally shown at 100. The scanner 100 may be implemented as a handheld scanner and may include at least one camera 102 and a set of projectors 104 mounted to a housing 106. The at least one camera 102 and the set of projectors 104 may be in communication with a processor circuit 103 via a wired connection and/or over a wireless network (not shown). The scanner 100 is generally configured to scan a surface 112 of a target object 110, and generate 3D coordinates corresponding to the surface 112 which may be used to re-create a 3D representation of the target object 110 (e.g., a 3D point cloud and/or a 3D polygonal mesh generated from the 3D point cloud). These features on the surface 112 are located at positions within a physical world reference frame 118

$$( [ \begin{matrix}{\hat{x}}_{w} \\ {\hat{y}}_{w} \\ {\hat{z}}_{w}\end{matrix} ] ) .$$

### Set of Cameras 102

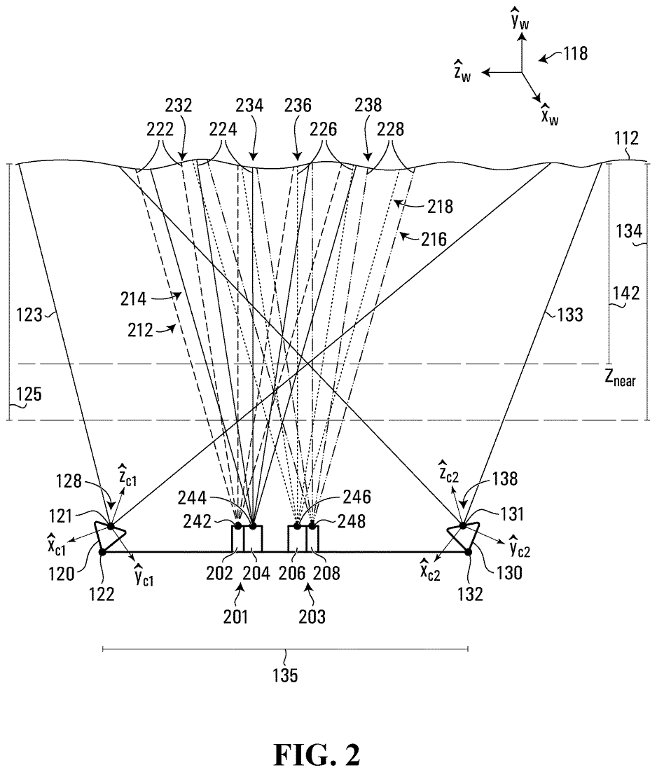

In the embodiment shown in FIGS. 1 and 2, at least one camera 102 includes a first camera 120 and a second camera 130; however, in other embodiments, the set of cameras 102 may include fewer or additional cameras, and may include only one of the first and second cameras 120 and 130 for example. The first and second cameras 120 and 130 capture a first image and a second image respectively of portions of the surface 112 at a same time point, or at substantially the same time point (collectively, tₙ, from slightly different perspectives. The two different images captured at tₙ, may collectively be referred to as a “frame” for that tₙ. The phrases “a same time point”, “tₙ” and/or “a particular tₙ” as used herein generally means time points where there is no relative displacement (or negligible relative displacement) between the target object 110 and the first and second cameras 120 and 130. The first and second images may be processed by the processor circuit 103 to determine 3D coordinates of features (or points) of the surface 112 using triangulation calculations and bundle adjustment calculations based on relative geometry of the first and second cameras 120 and 130, and intrinsic and extrinsic parameters of the first and second cameras 120 and 130. Accordingly, the scanner 100 may be referred to as a stereo-view scanner, a multi-view scanner or other term known to those skilled in the art. In embodiments where the at least one camera 102 only include a single camera, this single camera may capture different images corresponding to different portions of the surface 112 at different time points while the single camera is in a different pose relative to the target object 110.

The first and second cameras 120 and 130 may be monochrome cameras, visible color spectrum cameras, infrared cameras, or near infrared cameras or other types of cameras known to those skilled in the art. The type of the first and second cameras 120 and 130 may generally correspond to, and depend on, a type of light projected by the set of projectors 104. For example, in embodiments where the set of projectors 104 project visible light, the first and second cameras 120 and 130 may be monochrome or visible colour cameras; however, in embodiments where the projector 104 projects infrared or near infrared light, the first and second cameras 120 and 130 may be monochrome, infrared or near-infrared cameras.

Referring to FIGS. 1 and 2, the first camera 120 is mounted to the housing 106 at a first camera position 122 such that a first camera origin 121 is orientated in a first camera orientation O_{c1} which generally defines a first camera field-of-view (FOV) 123. In some embodiments, the first camera 120 may be considered an origin sensor of the scanner 100, and the first camera orientation O_{c1} may generally define a scanner reference frame 128

$${O}_{c 1} = [ \begin{matrix}{\hat{x}}_{c 1} \\ {\hat{y}}_{c 1} \\ {\hat{z}}_{c 1}\end{matrix} ] .$$

Points or features identified in the world reference frame 118 may be transformed into the scanner reference frame 128 with a rotation matrix Rₒ and a translation vector tₒ which combine to form extrinsic parameters Mₒ of the first camera 120 generally describing a pose of the first camera 120 in the world reference frame 118.

The second camera 130 is mounted to the housing 106 at a second camera position 132 such that a second camera origin 131 is orientated in a second camera orientation O_{c2} which generally defines a second camera FOV 133. The second camera orientation O_{c2} may be defined relative to the scanner reference frame 128, in which case

$${O}_{c 2} = [ \begin{matrix}{x}_{c 1} \\ {y}_{c 1} \\ {z}_{c 1}\end{matrix} ] ;$$

however, as the second camera orientation O_{c2} is often a parameter which is initially determined using the second images captured by the second camera 130, the second camera orientation O_{c2} may initially be defined in a second camera reference frame 138

$$( {O}_{c 2} = [ \begin{matrix}{\hat{x}}_{c 2} \\ {\hat{y}}_{c 2} \\ {\hat{z}}_{c 2}\end{matrix} ] ) .$$

Points or features identified within the second camera reference frame 138 may then be transformed into the scanner reference frame 128 with a rotation matrix Rₛ and a translation vector tₛ which combine to define stereo extrinsic parameters Mₛ of the second camera 130, generally describing a pose of the second camera 130 in the scanner reference frame 128 and relative to the first camera 120. In the embodiment shown, the camera separation distance 135 is approximately 316 mm; however, in other embodiments, the camera separation distance 135 may range between approximately 100 mm and 500 mm.

Generally, the camera separation distance 135, the first camera orientation O_{c1}, and the second camera orientation O_{c2} are configured such that the first camera and second camera FOVs 123 and 133 at least partially overlap each other. As a result, a first images captured by the first camera 120 and a second images captured by the second camera 130 for a particular tₙ are spatially neighbouring images. The phrase “spatially neighbouring images” as used herein generally means images which include a portion of overlap as between the images. This portion of overlap enables a same feature (or point) to be identified and matched as between different images of the spatially neighbouring images. This portion of overlap may include representations of a same portion of the target object 110. For a particular tₙ, a first image captured by the first camera 120 and a second image captured by the second camera 130 are generally spatially neighbouring images due to the at least partial overlap as between the first camera FOV 123 and the second camera FOV 133 described above. Over different time points, such as t₁, t₂, [ . . . ]tₙ for example, different images captured by a single camera, different first images captured by the first camera 120 and/or different second images captured by the second camera 130 may also be spatially neighbouring images, depending on a current pose of the scanner 100 relative to the target object 110 in the world reference frame 118. 3D coordinates

$$( e . g . , [ \begin{matrix}{x}_{w} \\ {y}_{w} \\ {z}_{w}\end{matrix} ]$$

in the world reference frame 118) corresponding to a feature of the surface 112 which is captured in the first and second images may be determined from its 2D coordinates in the first image and the second image, the camera separation distance 135, the first camera orientation O_{c1}, the second camera orientation O_{c2} and intrinsic and extrinsic parameters of the first and second cameras 120 and 130 using a combination of triangulation calculations and/or bundle adjustment calculations.

The phrase “camera FOV” as used herein generally means an area or an angular span over which a particular camera (e.g., the first or second cameras 120 or 130) can capture an object in an image above a given resolution. The phrase “camera DOF” as used herein generally means a depth over which a particular camera (e.g., the first or second cameras 120 or 130) can capture an object in an image above a given resolution. In the context of a camera used in a 3D scanner, this given resolution is typically a resolution required to extract, match and/or generate 3D coordinates for features of the object represented in the image captured by that particular camera. An area of the first and second camera FOVs 123 and 133 and a depth of the first and second camera DOFs 125 and 134 may vary depending on characteristics associated with the first and second cameras 120 and 130 as known to those skilled in the art. For example, the DOF of a camera may increase as an aperture of a camera decreases. Further, the area of the FOV of a camera may increase, while the DOF may increase, when the camera utilizes a lens with a reduced focal length (e.g., wide-angle lenses); in contrast the area of the FOV may decrease, while the DOF may decrease, when the camera utilizes a lens with an increased focal length (e.g., tele-photo lenses). Further still, the size of the FOV of a camera may increase when an image sensor of a camera increases in size.

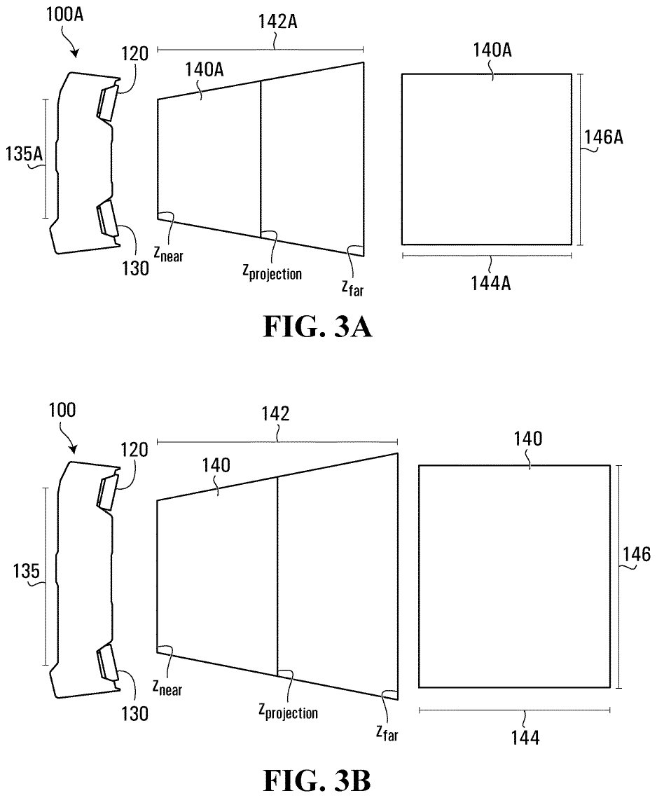

Referring to FIGS. 2, 3A and 3B, the area of the first and second camera FOVs 123 and 133, the depth of the first and second camera DOFs 125 and 134, and the camera separation distance 135 may combine to affect an area of a scanner FOV 140 and an overall depth of a scanner DOF 142 of the scanner 100. The phrase “scanner FOV” as used herein generally means an area or an angular span over which a processor circuit (e.g., the processor circuit 103) of the 3D scanner can substantially accurately determine 3D coordinates of features on a surface of an object based on images of the object captured by cameras (e.g., the first or second cameras 120 or 130) of the 3D scanner. The phrase “scanner DOF” as used herein generally means a depth over which the processor circuit can substantially accurately determine 3D coordinates of features on a surface of an object based on images of the object captured by the cameras. As the first and second camera FOVs 123 and 133 and DOFs 125 and 134 increase, the scanner FOV 140 and DOF 142 may similarly increase. The camera separation distance 135 may also significantly affect the scanner FOV 140 and DOF 142. For example, when the camera separation distance 135 increases, the scanner DOF 142 may increase as the first and second images captured by the first and second cameras 120 and 130 for particular tₙ may have a larger disparity for a particular feature which can be used to determine 3D coordinates of that particular feature.

As a specific example, a scanner 100A having a camera separation distance 135A of approximately 181 mm between the first and second cameras 120 and 130 is shown in FIG. 3A. The scanner 100A may have a scanner DOF 142A including a zₙₑₐᵣ of approximately 250 mm, a z_{projection} of approximately 300 mm, and a z_{far} of approximately 450 mm, and a scanner FOV 140A at z_{projection} with a width 144A of approximately 310 mm and a height 146A of approximately 350 mm. In contrast, the scanner 100 having the camera separation distance 135 of approximately 316 mm is shown in FIG. 3B. The scanner 100 may have the scanner DOF 142 including a zₙₑₐᵣ of approximately 350 mm, a z_{projection} of approximately 1200 mm, and a z_{far} of approximately 1500 mm, and the scanner FOV 140 at z_{projection} with a width 144 of approximately 1200 mm and a height 146 of approximately 1200 mm at z_{projection}. This increase in the scanner DOF 142 and scanner FOV 140 may allow the 3D scanner 100 to be positioned further away from a surface of a target object when compared to 3D scanner 100A, and allow the 3D scanner 100 to perform a 3D scan of larger target objects.

### Set of Projectors 104

In 3D scanners including a projector (or set of projectors), the projector may project concentrated light generated by a light source of the projector towards an object to be scanned. In some embodiments, the projector may generate light which resolves as a particular pattern (e.g., a plurality of lines, a plurality of dots, a grid, etc.) on a surface. This pattern may be a static pattern or a dynamically changing pattern.

As described in greater detail below, projectors associated with 3D scanners are often implemented as a “multiline projector” or “multielement projectors” which project a plurality of light planes or a plurality of light elements from a projector origin, but with an inter-beam angle separating two light planes/light elements. The plurality of light planes and/or elements then resolve as the light pattern comprising the plurality of lines, the plurality of dots, the grid, etc. when reflected by the surface of the target object. Such projectors have a field-of-projection (FOP) and a depth of projection (DOP) over which the projector is able to project the light or the light pattern. The phrase “projector FOP” as used herein generally means an area or an angular span over which a particular projector can project light onto a surface of an object above a given resolution. Similarly, the phrase “projector FOP” as used herein generally means a depth over with the projector can project light onto the surface above the given resolution. In the context of a projector used in a 3D scanner, this given resolution is typically a resolution required to extract and/or match the light lines and/or light elements on the surface using an image captured by at least one camera of the 3D scanner.

Generally, increasing a number and/or density of light lines (and/or light elements) projected onto the surface of a target object can increase 3D scanning speed and/or 3D scanning accuracy. However, the large separation camera distance 135 which allows the 3D scanner 100 to scan larger target objects may require the 3D scanner 100 to be positioned further away from the surface of the target object. With multiline or multielement projectors having the projector origin and the inter-beam angle described above, as the surface is positioned further away from the projector origin, a distance between two adjacent light lines (and/or adjacent light elements) resolving on the surface increases and an overall density of light lines resolving on the surface decreases. This reduction in the number and/or density of light lines (and/or light elements) can reduce scanning speed and/or scanning accuracy.

To counter this problem with decreased density between light lines (and/or light elements) as the surface is positioned further away from the projector origin, it may be possible to decrease the FOP of the projector (resulting in a same number, but increased density, of light lines and/or light elements) and/or increase a number of light planes projected by the projector (resulting in both increasing number and density of light lines and/or light elements). However, decreasing the span of the FOP of the projector may be counterproductive for scanning larger target objects, as more frames may need to be captured by the 3D scanner 100. However, simply increasing a number of light planes (and/or the light elements) projected by the light projector over a same FOP can further divide power of a light source associated with the light projector, which can reduce the power and brightness of each light plane (and/or each light element) and each light line eventually resolved on the surface. Spreading the power of the light source over a large number of light planes can result in light lines which are too faint to be used for the 3D scanning procedure. Thus, it may be necessary to increase the power of the light source to project a larger number of light planes while preserving brightness. However, simply increasing the power of the light source may cause the projector to exceed certain laser eye-safety standards and may require an operator to use protective eye equipment when utilizing a 3D scanner incorporating such a projector.

More specifically laser eye-safety standards have been established to set an allowable amount of laser radiation that can enter an eye without causing eye damage, both with and without protective eye equipment. These standards require products emitting laser light to be labelled so that consumers understand safety risks associated with that product. One such standard is IEC 60825-1, published by the International Electrotechnical Commission (IEC), which has been adopted in Europe as EN 60825-1. Another such standard is ANSI Z136.1 Standard (Z136.1-2000), published by American National Standards Institute (ANSI) and CDRH 21 CFR 1040.10, published by the Centre for Devices and Radiological Health (CDRH) which is used in the United States. Compliance with IEC 60825-1 has been established as acceptable to meet the standards used in the United States. IEC 60825-1 divides products emitting laser light into one of broad hazard classes noted below:
Class 1 and 1M lasers which are very low risk and “safe under reasonably foreseeable use”.
Class 2 and 2M lasers which are safe if not viewed through optical instruments.
Class 3R and 3B lasers which are potentially hazardous under direct beam viewing conditions but are normally safe when viewing diffuse reflection viewing conditions.
Class 4 lasers which are hazardous under both direct beam viewing conditions and diffuse reflection viewing conditions, and may also cause skin injuries and are potential fire hazards.

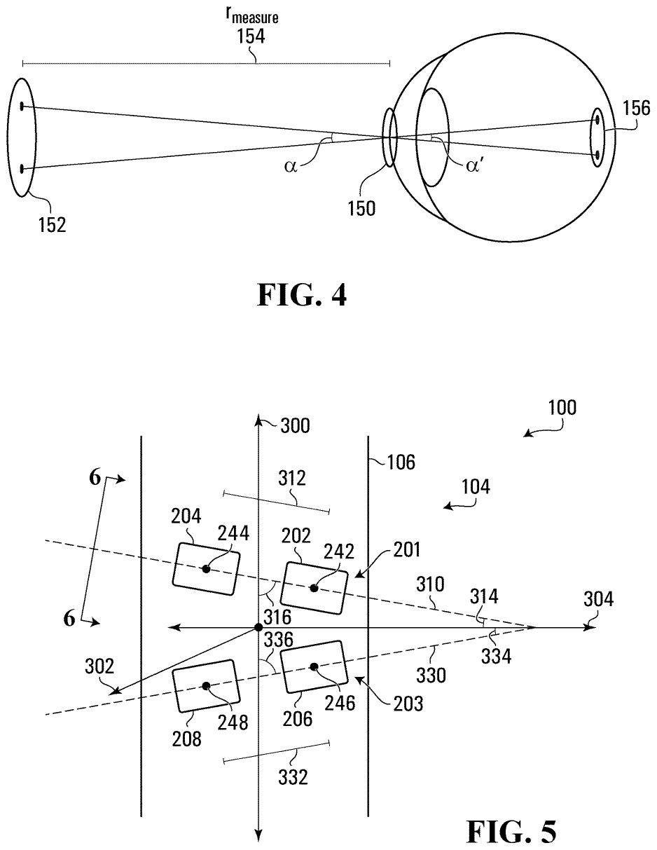

Referring to FIG. 4, the laser eye safety standard classes above are typically assessed based on a ratio amount of accessible emissions (AE) to accessible emissions limit (AEL),

$$e . g . , \frac{AE}{AEL} ,$$

assessed using an assessment aperture 150 of a projector source 152 (also referred to as a “projector origin”) positioned a measurement distance 154 rₘₑₐₛᵤᵣₑ away from the projector origin 152. Generally, this assessment aperture 150 is intended to represent a “retinal image” 156 of the projector origin 152 as seen by a typical human eye. A precise size of the assessment aperture 150 and the measurement distance 154 depends on characteristics of the projector, including wavelength of the light projected by the projector. For example, for light within the visible spectrum (400-780 nm), the assessment aperture 150 has a diameter of approximately 7 mm and the measurement distance 154 rₘₑₐₛᵤᵣₑ is positioned approximately 100 mm away from the projector origin 152. However, for light within the infrared spectrum (780-1400 nm), a diameter and an assessment position of the assessment aperture 150 may be different. The AE is the measured amount of energy density (such as W/mm² or J/mm²) projected by the projector multiplied by an area of the assessment aperture 150. The AEL is an upper limit of a maximum amount of allowed energy allowed within the assessment aperture 150 for the projector to be categorized into a particular class. The AEL takes into account spatial distribution of the projector origin (and also spatial distribution of a group of projector origins assessed together) utilizing the factor C₆. The factor C₆ may also be used to account for other characteristics of the projector source 152 or the projected light. For example, the AEL for Class 2M is C₆·1 mW or C₆·10⁻³ W. In embodiments where the projector origin is a single projector origin of a single point, the factor C₆ may be 1 or negligible. In embodiments where the apparent projector origin 152 is an elongated diffuse origin spread out in space and/or more than one projector origin spread out in space (as shown in FIG. 4), the factor C₆ depends on how the typical human eye would perceive the spread, and is modified based on at least one angular subtense α (generally one a for length and one a for width of the source). The angular subtense α is the angle of the spread of the apparent projector source 152 to the human eye. In some situations, as the spread of the apparent projector source 152 increases (either due to an increase in spread of the diffuse origin or separation distance between different projector origins and resulting corresponding increase in the at least one angular subtense α), the factor C₆ increases. As the factor C₆ increases, the AEL for a projector to be categorized into a particular class can also increase.

It may be desirable to ensure that light elements projected by the set of projectors 104 complies with at least the Class 2 and Class 2M standards. This may allow the scanner 100 incorporating the set of projectors 104 to be operated by an operator without additional protective eye equipment. For the set of projectors 104 to comply with at least the Class 2 and Class 2M standards while increasing the number and/or density of the light elements projected by the set of projectors 104, the set of projectors 104 may be implemented as two or more multiline and/or multielement projectors which each project a respective plurality of light elements that resolves as respective multiline patterns on a surface of a target object. The respective multiline patterns of each projector may combine on the surface to form a denser interleaved pattern. Having two or more projectors in the set of projectors 104 can allow a projector origin of each projector to be spread out in space relative to each other, which can increase the factor C₆ used to analyze the set of projectors 104. As described above, increasing the factor C₆ can allow that particular set of projectors 104 to fall within the Class 2 and 2M standards while projecting a larger number of light elements in some embodiments.

### Set of Projectors 104

Referring now to FIGS. 1, 2 and 4, in the embodiment shown, the set of projectors 104 includes a top set of projectors 201 and a bottom set of projectors 203. The top and bottom sets of projectors 201 and 203 may also be referred to as a first and a second set of projectors 201 and 203. The top set of projectors 201 includes a first top projector 202 and a second top projector 204, while the bottom set of projectors 203 includes a first bottom projector 206 and a second bottom projector 208. In some embodiments, a particular set of projectors 201 and 203 may include more than two projectors, and may include three projectors, four projectors, six projectors, 10 projectors, 20 projectors etc., depending on a desired overall width and height of the interleaved pattern to be generated by that particular set of projectors 201 and 203. In embodiments where the set of projectors 104 includes both the top and bottom sets of projectors 201 and 203, one of the top or the bottom sets of projectors 201 and 203 may only include the corresponding first projector 202 and 206 or only include the corresponding second projector 204 or 208. In some further embodiments, the set of projectors 104 may only include one of the top set of projectors 201 or the bottom set of projectors 203. In some still further embodiments, the set of projectors 104 may include additional sets of projectors, such as a third set of projectors, a fourth set of projectors, a fifth set projectors, etc.

Referring to FIG. 2, in the embodiment shown, the projectors 202, 204, 206 and 208 are each a multiline projector and each project a corresponding plurality of light planes 212, 214, 216 and 218 from a corresponding projector origin 242, 244, 246 and 248. Light planes 212, 218 and 216 are shown in dashed and/or dotted lines for illustrative clarity only; the light planes projected by the projectors 202, 204, 206 and 208 may generally comprise a solid plane. As briefly described above, the light planes 212, 214, 216 and 218 may be projected by the projectors 202, 204, 206 and 208 as visible light, infrared light, or near-infrared light. When projected onto the surface 112, each of the plurality of light planes 212, 214, 216 and 218 resolve as a respective and corresponding plurality of light lines 222, 224, 226 and 228 and form a respective and corresponding multiline pattern 232, 234, 236 and 238. More specifically, the first top projector 202 projects the plurality of light planes 212 from the first top projector origin 242 which resolves as the multiline pattern 232 including the plurality of light lines 222 on the surface 112; the second top projector 204 projects the plurality of light planes 214 from the second top projector origin 244 which resolves as the multiline pattern 234 including the plurality of light lines 224 on the surface 112; the first bottom projector 206 projects the plurality of light planes 216 from the first bottom origin 246 which resolves as the multiline pattern 236 including the plurality of light lines 226 on the surface 112; and the second bottom projector 208 projects the plurality light planes 218 from the second bottom projector origin 248 which resolves as the multiline pattern 238 including the plurality of light lines 228 on the surface 112. In other embodiments, the projectors 202, 204, 206 and 208 may instead comprise alternative multielement projectors, such as a multidot projectors projecting a plurality of dots for example; in such embodiments, the light planes may instead comprise light columns. In embodiments where each set of projectors 201 and 203 includes additional projectors or additional sets of projectors, each additional projector may project a further corresponding plurality of light planes or other light elements.

Representations of the plurality of the light lines 222, 224, 226 and 228 (or portions thereof) reflected on the surface 112 may be included in the images of the surface 112 captured by the first and second cameras 120 and 130 and may be transmitted to the processor circuit 103. The processor circuit 103 may utilize the representations of the light lines 222, 224, 226 and 228 in the images of a same frame to assist in determining 3D measurements of the surface 112. In particular, the representations of the light lines 222, 224, 226 and 228 on the surface 112 may function as features (or points) to be extracted from the images and matched across different first and second images of a same frame captured by the first and second cameras 120 and 130 for a particular t, for example.

In the embodiment shown, the multiline patterns projected by the projectors of each respective set of projectors 201 and 203 are designed and configured to be concurrently projected to form a larger interleaved pattern. The phrase “concurrently” as used herein generally means that there is a period of overlap as between when the projectors of a particular set of projectors 201 and 203 will project their respective multiline patterns. For example, the first top projector 202 may project the first top multiline pattern 232 for a first time period and the second top projector 204 may project the second top multiline pattern 234 for a second time period. The first and second top multiline patterns 232 and 234 may be projected “concurrently” when the first and second time periods have a period of overlap. This period of overlap allows their respective multiline patterns 232 and 234 to combine to form the larger interleaved pattern 231.

The phrase “interleaved pattern” as used herein generally means a larger and/or denser pattern formed by concurrently projecting at least two smaller patterns emitted by, respectively, at least two respective projectors. In some embodiments, the smaller patterns may be less than dense than the interleaved pattern; in other embodiments, the smaller patterns may have a smaller angular span or a smaller FOP than the interleaved pattern. Specifically, the multiline pattern 232 projected by the first top projector 202 is designed, positioned or otherwise configured to combine with the multiline pattern 234 projected by the second top projector 204 to generate a larger top interleaved pattern 231. More specifically, the multiline pattern 232 and the multiline pattern 234 may be combined in a manner such that one line of the plurality of light lines 222 projected by the first top projector 202 is projected onto the surface 112 between two lines of the plurality of lines 224 projected by the second top projector 204 to generate the top interleaved pattern 231. Similarly, the multiline pattern 236 projected by the first bottom projector 206 is designed, positioned or otherwise configured to combine with the multiline pattern 234 projected by the second bottom projector 208 to generate a larger bottom interleaved pattern 239. As described above, representations of the combined interleaved patterns 231 and 239 (or portions thereof) reflected on the surface 112 may be included in the images of the surface 112 captured by at least one of the first and second cameras 120 and 130 and may be transmitted to the processor circuit 103. The processor circuit 103 may utilize the representations of the combined interleaved patterns 231 and 239 in the images (such as images of a same frame) to assist in determining 3D measurements of the surface 112. In particular, the representations of representations of the combined interleaved patterns 231 and 239 may function as features (or points) to be extracted from the images and matched across different first and second images of a same frame captured by the first and second cameras 120 and 130 for a particular t, for example.

More specifically, the multiline pattern 236 and the multiline pattern 238 may be combined in a manner such that one line of the plurality of lines 226 projected by the first bottom projector 206 is projected onto the surface 112 between two lines of the plurality of lines 228 projected by the second bottom projector 208 to generate the bottom interleaved pattern 239. This may allow each projector of a particular set of projectors 201 and 203 to emit fewer light planes, while still generating the larger and/or denser interleaved patterns 231 and 239. Emitting fewer light planes can allow each light plane to be higher intensity for a given power of the light source, as light emitted by the light source has a reduced area. Further, utilizing two different projector origins which are separated in space (such as the projector origins 242 and 244 and the projector origins 246 and 248) to project a combined interleaved pattern may also increase the factor C₆ used to assess the eye safety of the combined set of projectors 201 and/or 203.

### Top Set of Projectors 201 and First Embodiment of Interleaved Pattern 231

Referring now to FIGS. 5-7 and 8A-8C, the top set of projectors 201 including the first top projector 202 (also referred to as the “first projector 202”) and the second top projector 204 (also referred to as the “second projector 204”) will be described in greater detail below. Those skilled in the art will recognize that the below description may similarly be applicable to the bottom set of projectors 203 (in embodiments where the scanner 100 includes the bottom set of projectors 203) or any other set of projectors (in embodiments where the scanner 100 includes further or alternative sets of projectors).

Referring to FIG. 5, the housing 106 of the scanner 100 includes a physical height axis 300, a physical depth axis 302, and a physical width axis 304. The first and second projectors 202 and 204 are mounted to the housing 106 aligned along a baseline 310. In the embodiment shown, the baseline 310 is at an hd angle 316 relative to a hd scanner plane defined by the height and depth axes 300 and 302 of the scanner 100 and is at an wd angle 314 relative to a wd scanner plane defined by the width and depth axes 304 and 302. In the embodiment shown, the hd angle 316 is approximately 15°; however, in other embodiments, the hd angle 316 may range between approximately 0° (i.e., substantially parallel to the hd scanner plane) and 90°. In the embodiment shown, the wd angle 314 is approximately 30°; however, in other embodiments, the wd angle 314 may range between approximately 0° (i.e., substantially parallel to the wd scanner plane) and 90°.

The first and second projector origins 242 and 244 and are separated by a set separation distance 312 along the baseline 310. In the embodiment shown, the set separation distance 312 is approximately 12 mm; however, in other embodiments, the set separation distance 312 may range between approximately 5 mm and 50 mm. The set separation distance 312 between the two projector origins 242 and 244 may increase the factor C₆ of the set of projectors 201. For example, in the embodiment shown, the factor C₆ of the set of projectors 201 may be approximately 15× more than the factor C₆ of a set of projectors which projects the interleaved pattern 231 using a single projector origin. In other embodiments, the set separation distance 312 may increase the factor C₆ to anywhere between approximately 2× more and 50× more.

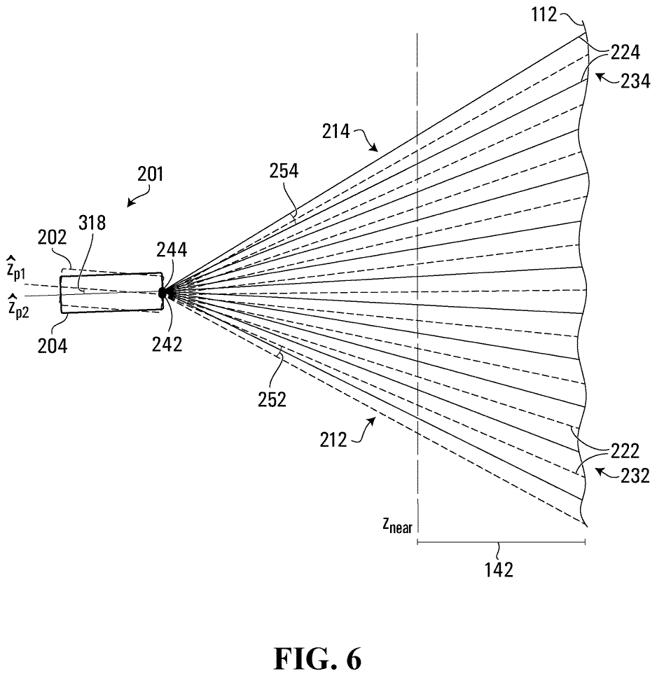

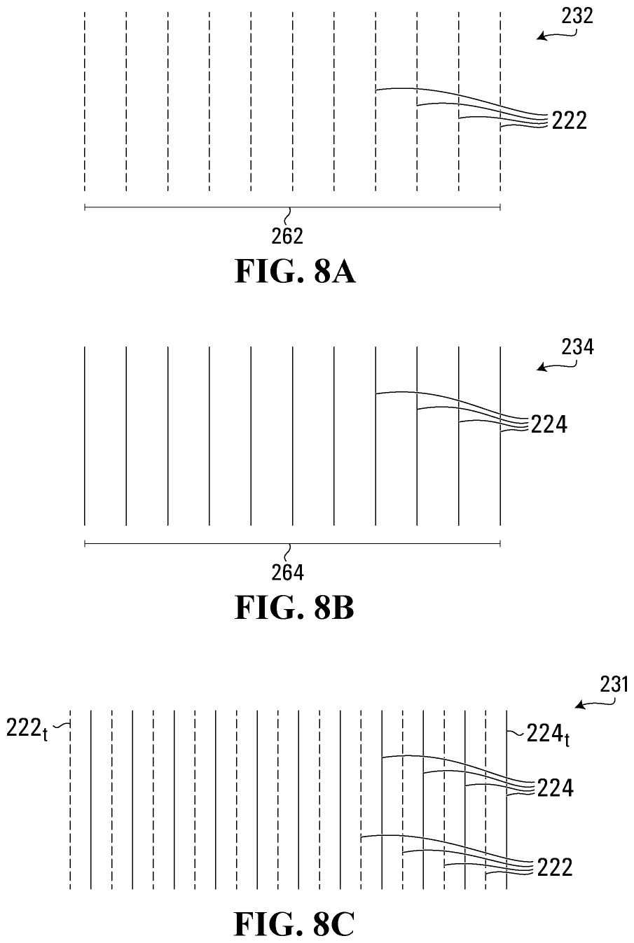

As described above, in the embodiment shown, the first projector 202 and the second projector 204 are both multiline projectors. The first projector 202 projects the first plurality of light planes 212 (shown in FIG. 6) resolving as the first multiline pattern 232 including the first plurality of light lines 222 (best seen in FIG. 8A) on the surface 112. The first plurality of light lines 222 are shown in dashed lines in FIG. 8A for illustrative clarity only; the actual light lines 222 resolved on the surface 112 may be solid light lines, dashed light lines, dotted light lines and/or light lines comprised of variety of different light elements. The second projector 204 projects the second plurality of light planes 214 (shown in FIG. 6) resolving as the second multiline pattern 234 including the second plurality of light lines 224 (best shown in FIG. 8B) on the surface 112. The second plurality of light lines 224 are shown in solid lines in FIG. 8B for illustrative clarity only; the actual light lines 224 resolved on the surface 112 may be solid light lines, dashed light lines, dotted light lines and/or light lines comprised of other different light elements. In the embodiment shown, the first plurality of light planes 212 projected by the first projector 202 and the second plurality of light planes 214 projected by the second projector 204 are substantially identical and each comprise 11 light planes; however, in other embodiments, the first and second plurality of light planes 212 and 214 may each comprise anywhere between two and 200 light planes, and may each comprise three light planes, five light planes, seven light planes, nine light planes, 15 light planes, 19 light planes, 33 light planes, 59 light planes, 65 light planes, or 99 light planes for example.

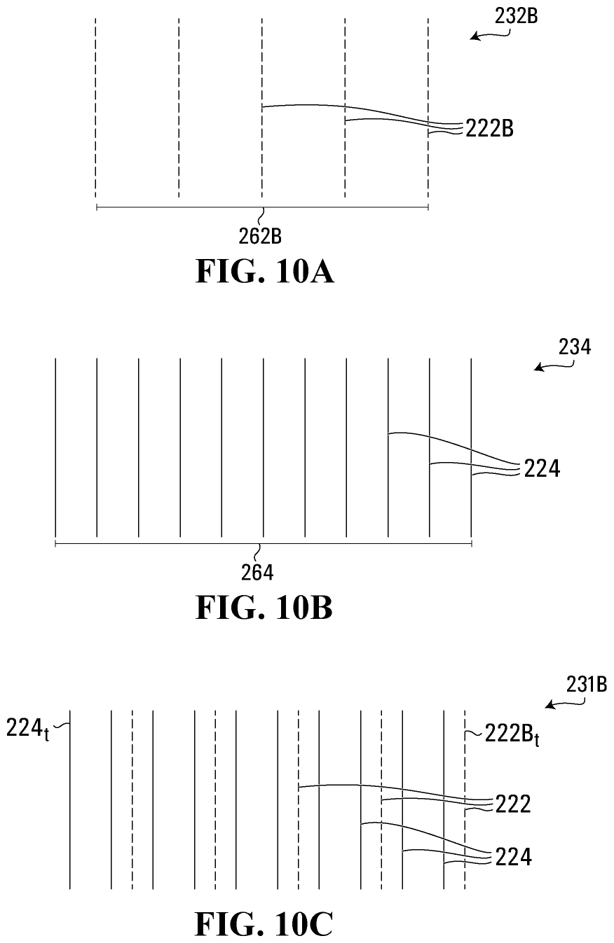

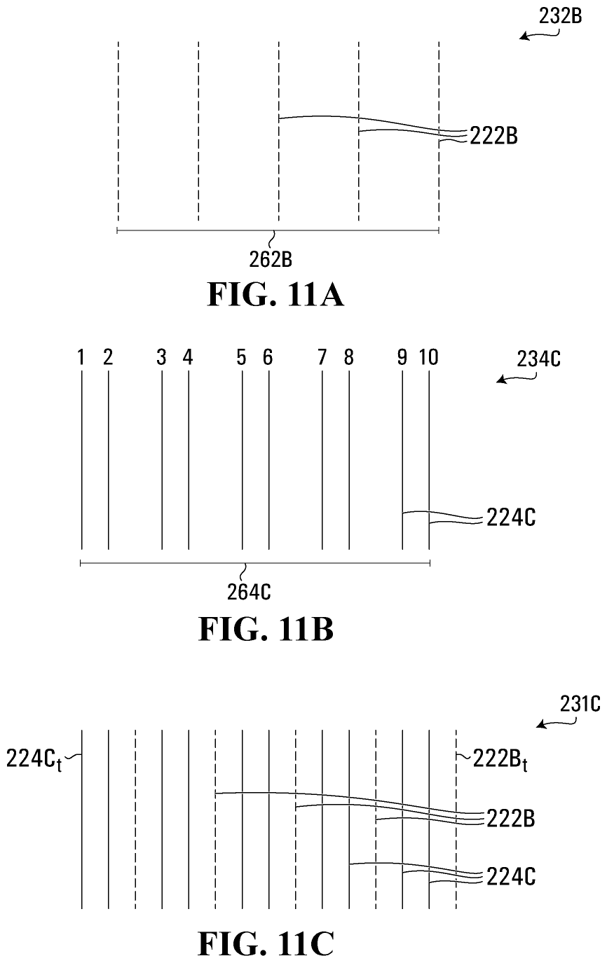

In the embodiment shown, the first plurality of light planes 212 comprise non-intersecting light planes and each light plane 212 may be separated from an adjacent light plane 212 by a first inter-beam angle 252 (shown in FIG. 6). A first projector span 262 (shown in FIG. 8A) depends on the first inter-beam angle 252 and a number of light planes in the first plurality of light planes 212 projected by the first projector 202. In the embodiment shown, each first inter-beam angle 252 between each two adjacent light planes 212 are substantially identical, which generates the corresponding first multiline pattern 232 having the first plurality of light lines 222 which are equidistant from each other (best seen in FIG. 8A). In the embodiment shown, the first inter-beam angle 252 is approximately 3.26°, forming the first projector span 262 of approximately 34°. However, in other embodiments, the first inter-beam angle 252 between different ones of the light planes 212 may range between approximately 0.1° and approximately 5° (similar to embodiments described below in association with FIGS. 10A and 11A), depending on desired characteristics of the first multiline pattern 232, a desired number of the first plurality of light planes 212, a desired dimension of the first projector span 262, and other characteristics of the scanner 100 as known to those skilled in the art. Examples of different inter-beam angles associated with different numbers of planes in a plurality of light planes projected by a particular projector is produced in Table 1 below. Further, in some embodiments, the first inter-beam angles 252 as between different ones of two adjacent light planes 212 may be different, which may generate a first multiline pattern having clustered non-equidistant lines (similar to embodiments described below in association with FIG. 11B).

TABLE 1

| Number of light elements | Inter-beam angle |
|---|---|
| 3 | 1.5° |
| | 5.0° |
| 5 | 0.23° |
| | 0.5° |
| | 1.55° |
| 7 | 5° |
| 9 | 0.11° |
| 11 | 1.5° |
| 15 | 2.3° |
| 19 | 0.77° |
| 33 | 0.38° |
| 59 | 0.65° |
| 65 | 0.34° |
| | 0.4° |
| 99 | 0.149° |

Similarly, the second plurality of light planes 214 comprise non-intersecting light planes and each light plane 214 may be separated from an adjacent light plane 214 by a second inter-beam angle 254 (shown in FIG. 6). A second projector span 264 (shown in FIG. 8B) depends on the second inter-beam angle 254 and a number of light planes in the second plurality of light planes 214 projected by the second projector 204. In the embodiment shown, each second inter-beam angle 254 between each two adjacent light planes 214 are substantially identical, which generates the corresponding second multiline pattern 234 having the second plurality of light lines 224 which are equidistant from each other (best seen in FIG. 8B). Similar to the first inter-beam angle 252, the second inter-beam angle 254 is also approximately 3.26°, forming the second projector span 264 of approximately 34°. However, in other embodiments, the second inter-beam angle 254 between different ones of the light planes 214 may range between approximately 0.1° and approximately 5° (similar to embodiments described below in association with FIGS. 10A and 11A), depending on desired characteristics of the second multiline pattern 234, a desired number of the second plurality of light planes 214, a desired dimension of the second projector span 264, and other characteristics of the scanner 100 as known to those skilled in the art. Examples of different inter-beam angles associated with different numbers of planes is produced in Table 1 above. Further, in some embodiments, the second inter-beam angles 254 as between different ones of two adjacent light planes 214 may be different, which may generate a second multiline pattern having clustered non-equidistant lines (described below in association with FIG. 11B). In other embodiments, the first and second inter-beam angles 252 and 254 may be different (described below in association with FIGS. 10A-10C).

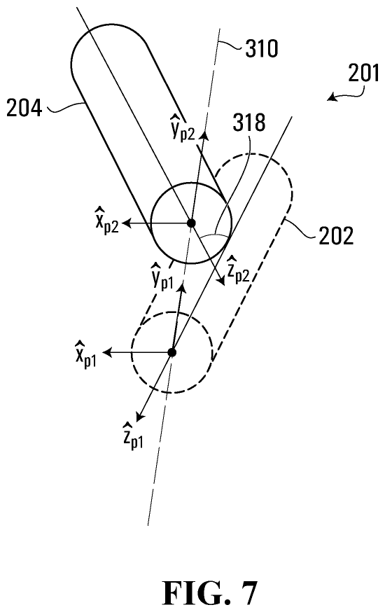

Referring to FIGS. 6 and 7, in the embodiment shown, the first projector 202 is mounted to the housing 106 with the first projector origin 242 positioned at a first projector orientation

$$( {O}_{p 1} = [ \begin{matrix}{\hat{x}}_{p 1} \\ {\hat{y}}_{p 1} \\ {\hat{z}}_{p 1}\end{matrix} ] )$$

and the second projector 204 is mounted to the housing 106 with the second projector origin 244 positioned at a second projector orientation

$$( {O}_{p 2} = [ \begin{matrix}{\hat{x}}_{p 2} \\ {\hat{y}}_{p 2} \\ {\hat{z}}_{p 2}\end{matrix} ] ) .$$

The first and second projector orientations Oₚ₁ and Oₚ₂ may be positioned such that the first and second projector origins 242 and 244 are offset by a projector offset angle 318 (shown in FIG. 7). The projector offset angle 318 may be configured relative to the first inter-beam angle 252 and the second inter-beam angle 254, such that the first multiline pattern 232 projected by the first projector 202 and the second multiline pattern 234 projected by the second projector 204 may be combined into the top interleaved pattern 231 when projected concurrently. More specifically, the projector offset angle 318, relative to the first inter-beam angle 252 and the second inter-beam angle 254, may be configured such that one light line of the first plurality of light lines 222 forming the first multiline pattern 232 is projected onto the surface 112 between (also referred to as interleaved between) two light lines of the second plurality of light lines 224 forming the second multiline pattern 234 to generate the top interleaved pattern 231. Further, the projector offset angle 318 may be configured relative to the first inter-beam angle 252 and the second inter-beam angle 254, such that a light plane 212 projected by the first projector 202 defining the one light line 222 of the first multiline pattern 232 and two light planes 214 projected by the second projector 204 defining the two light lines 224 of the second multiline pattern 234 is non-intersecting throughout the scanner DOF 142. In some embodiments, the light plane 212 defining the one light line 222 and the two light planes 214 defining the two light lines 224 may be non-intersecting throughout an entire projection depth of the first and second projectors 202 and 204, and/or non-intersecting throughout a scanning volume of the 3D scanner 100.

As described above, representations of the combined interleaved pattern 231 (or portions thereof) reflected on the surface 112 may be included in the images of the surface 112 captured by at least one of the first and second cameras 120 and 130 and may be transmitted to the processor circuit 103. The processor circuit 103 may utilize the representations of the combined interleaved pattern 231 in the images (and as distorted by contours of the surface 112) to assist in determining 3D measurements of the surface 112. The light planes 212 and 214 being non-intersecting throughout the scanner DOF 142 may allow the light lines 222 and 224 to resolve as discrete light lines on the surface 112 and may enable the processor circuit 103 to reduce ambiguity in determining the 3D measurements in some embodiments.

In the embodiment shown, the projector offset angle 318 may be an offset between a yzₚ₁ first projector plane defined by the first projector ŷₚ₁ axis and the first projector \hat{z}ₚ₁ axis relative to a yzₚ₂ second projector plane defined by the second projector ŷₚ₂ axis and the second projector \hat{z}ₚ₂ axis (best shown in FIG. 7). Aligning the first and second projector origins 242 and 244 along the top baseline 310 while offsetting the yzₚ₁ first projector plane and the yzₚ₂ second projector plane by the projector offset angle 318 may enable the first plurality of light planes 212 projected by the first projector 202 to be non-intersecting with the second plurality of light planes 214 projected by the second projector 204 throughout the scanner DOF 142 (and/or throughout the entire projection depth of the first and second projectors 202 and 204) when the first and second plurality of light planes 212 and 214 are projected concurrently. In other embodiments, a xyₚ₁ first projector plane defined by the first projector \hat{x}ₚ₁ axis and the first projector ŷₚ₁ axis may be offset by the projector offset angle 318 relative to a xyₚ₂ second projector plane defined by the second projector \hat{x}ₚ₂ axis and the second projector ŷₚ₂ axis (not shown). In yet other embodiments, a xzₚ₁ first projector plane defined by the first projector \hat{x}ₚ₁ axis and the first projector \hat{z}ₚ₁ axis may be offset by the projector offset angle 318 relative to a xzₚ₂ second projector plane defined by the second projector \hat{x}ₚ₂ axis and the second projector \hat{z}ₚ₂ axis (also not shown).

The projector offset angle 318 may be a function of at least one of a number of projectors in the set of projectors 201, the first inter-beam angle 252 between the light planes 212 projected by the first projector 202 or the second inter-beam angle 254 between light planes 214 projected by the second projector 204. In embodiments where the first and second inter-beam angles 252 and 254 are substantially identical, the projector offset angle 318 may be

$$\frac{1}{n}$$

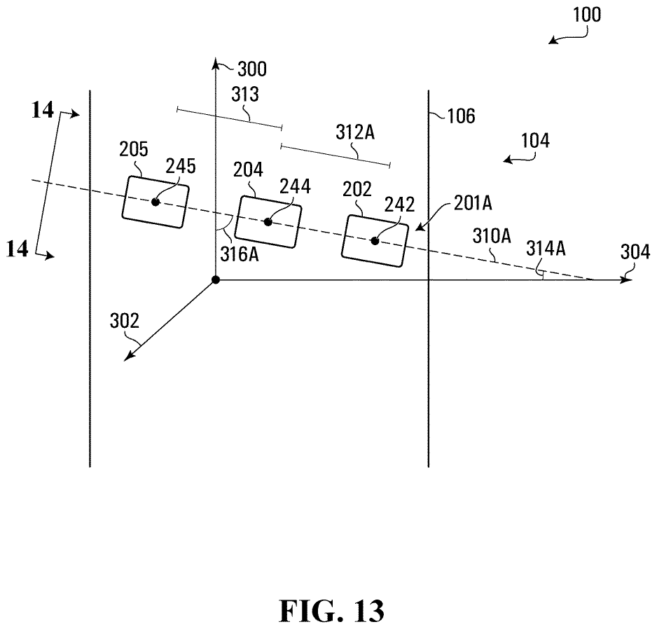

of the first and second inter-beam angles 252 and 254, wherein n is the number of projectors in the set of projectors 201. For example, in the embodiment shown in FIGS. 6 and 8A-8C, the first and second inter-beam angles 252 and 254 are substantially identical and are both 3.26°, the set of projectors 201 includes two projectors, and the projector offset angle 318 may be approximately 1.6° (being approximately ½ of the first and second inter-beam angles 252 and 254 of 3.26°). In embodiments where the set of projectors 201 includes three projectors, the projector offset angles may be approximately ⅓ of the inter-beam angles (described below in association with FIGS. 13-15 and 16A-16D), in embodiments including four projectors, the projector offset angles may be approximately being ¼ of inter-beam angles, etc.

The above combination of projector offset angle 318 relative to the first and second inter-beam angles 252 and 254 may generally position at least one light line 222 projected by the first projector 202 immediately adjacent and equidistant between (also referred to as interleaved between) two light lines 224 projected by the second projector 204 in the interleaved pattern 231 (shown in FIG. 8C); similarly at least one light line 224 projected by the second projector 204 may be positioned immediately adjacent and equidistant between (also referred to as interleaved between) two light lines 222 projected by the first projector 202 in the interleaved pattern 231 (again, shown in FIG. 8C). This results in a final interleaved pattern 231 having substantially equidistant light lines 222 and 224 as shown in FIG. 8C when the first and second multiline patterns 232 and 234 are concurrently projected. The final interleaved pattern 231 is denser than the first and second multiline patterns 232 and 234. Further, in embodiments where the first and second plurality of light planes 212 and 214 include a same number of light planes, the above combination of projector offset angle 318 relative to the first and second inter-beam angles 252 and 254 may generally position every light line 222 (except a terminal light line 222ₜ) projected by the first projector 202 between two light lines 224 projected by the second projector 204; similarly every light line 224 (except a terminal light line 224ₜ) projected by the second projector 204 may be positioned between two light lines 222 projected by the first projector 202 (again, shown in FIG. 8C). As a result of the terminal light lines 222ₜ and 224ₜ, the interleaved pattern 231 may also be larger (e.g. have a larger projector span) when compared to the first and second multiline patterns 232 and 234.

### Second Embodiment of Interleaved Pattern 231A

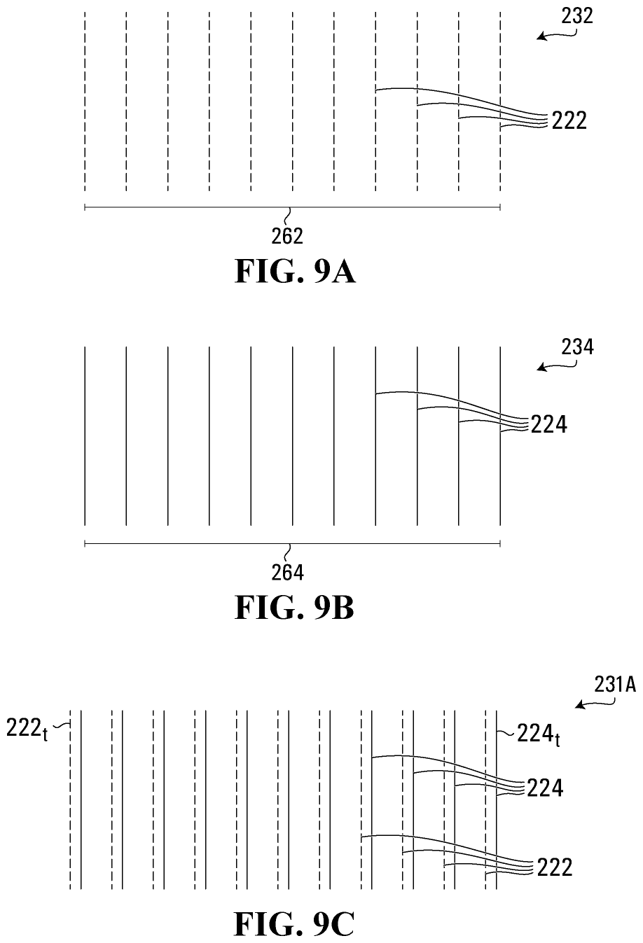

Another embodiment of a top interleaved pattern 231A formed from a combination of the first multiline pattern 232 and the second multiline pattern 234 is shown in FIGS. 9A-9C. Referring to FIG. 9A, the first plurality of light planes 212 projected by the first projector 202 resolving as the first multiline pattern 232 including the first plurality of light lines 222 on the surface 112 is the same as that described in association with FIG. 8A. Similarly, referring to FIG. 9B, the second plurality of light planes 214 projected by the second projector 204 resolving as the second multiline pattern 234 including the second plurality of light lines 224 on the surface 112 is the same as that described in association with FIG. 8B. However, to generate the interleaved pattern 231B shown in FIG. 8C, the first and second projector origins 242 and 244 of the first and second projectors 202 and 204 may be offset by a different projector offset angle 318B (not shown). In the embodiment shown, the projector offset angle 318B is 1.1° (being approximately ⅓ of the first and second inter-beam angles 252 and 254 of 3.26°). In other embodiments, the projector offset angle 318 may range between

$$\frac{1}{10} and \frac{9}{10}$$

of the first and second inter-beam angles 252 and 254.

The above combination of projector offset angle 318B relative to the first and second inter-beam angles 252 and 254 may generally position at least one light line 222 projected by the first projector 202 immediately adjacent, but closer to one light line 224 of (still referred to as interleaved between), two light lines 224 projected by the second projector 204; similarly at least one light line 224 projected by the second projector 204 may be positioned immediately adjacent, but closer to one light line 222 of (still referred to as interleaved between), two light lines 222 projected by the first projector 202. This results in a final interleaved pattern 231A having clustered light lines 222 and 224 as shown in FIG. 9C when the first and second multiline patterns 232 and 234 are concurrently projected. The resulting interleaved pattern 231A is denser and slightly larger (by virtue of the first and second terminal light lines 222ₜ and 224ₜ) than the first and second multiline patterns 232 and 234. Representations of the combined interleaved pattern 231A (or portion thereof) reflected on the surface 112 may be included in the images of the surface 112 captured by at least one of the first and second cameras 120 and 130 and may be transmitted to the processor circuit 103. The processor circuit 103 may utilize the representations of the combined interleaved pattern 231A in the images (and as distorted in the images by contours of the surface 112 for example) to assist in determining 3D measurements of the surface 112.

Further, in embodiments where the first and second plurality of light planes 212 and 214 include a same number of light planes and a projector offset angle 318 which is greater than approximately 0% and less than approximately 1/1 (i.e., 100%) of the first and second inter-beam angles 252 and 254, every light line 222 (except the terminal light line 222ₜ) projected by the first projector 202 may be positioned between two light lines 224 projected by the second projector 204; similarly every light line 224 (except the terminal light line 224ₜ) projected by the second projector 204 may be positioned between two light lines 222 projected by the first projector 202 (shown in FIGS. 8C and 9C). However, in some embodiments, the projector offset angle 318 may be more than approximately 100% of the first and second inter-beam angles 252 and 254. Where the projector offset angle 318 is a percentage greater than approximately 100% of the first and second inter-beam angles 252 and 254 (not shown), some light lines projected by one projector may be immediately adjacent light lines projected by the other projector (e.g., light lines in the middle of the interleaved pattern), whereas other lines projected by the one projector may instead be immediately adjacent light lines projected by a same projector (e.g., light lines at the periphery of the interleaved pattern). The resulting interleaved pattern 231 (not shown) may be larger than the first and second multiline patterns 232 and 234, may be denser in a middle where the first and second multiline patterns 232 and 234 are interleaved, but may be of same density at respective peripheries where the first and second multiline patterns 232 and 234 are not interleaved. Additionally, to avoid overlap between a light line of the first plurality of light lines 222 and a light line of the second plurality of light lines 224, the projector offset angle 318 is typically not 0%, 100%, or a multiple of 100% (e.g., 200%, 300%, 400%, etc.) of the first and second inter-beam angles 252 and 254.

### Third Embodiment of Interleaved Pattern 231B

Another embodiment of a top interleaved pattern 231B formed from a combination of a first multiline pattern 232B and the second multiline pattern 234 is shown in FIGS. 10A-10C. Referring to FIG. 10B, the second plurality of light planes 214 projected by the second projector 204 resolving as the second multiline pattern 234 including the second plurality of light lines 224 on the surface 112 is the same as that described in FIGS. 8B and 9B. Specifically, the second projector 204 projects 11 light planes 214 which resolves as a corresponding 11 light lines 224 on the surface 112. The second inter-beam angle 254 as between each light plane 214 of the second plurality light planes 214 is approximately 3.26°.

However, as described above, in some embodiments, the first and second inter-beam angles 252 and 254 may be different, and the number of light planes projected by the first and second projectors 202 and 204 may be different. Referring to FIG. 10A, the first projector 202 projects a first plurality of light planes 212B (not shown) which resolves as the first multiline pattern 232B including the first plurality of light lines 222B on the surface 112. In the embodiment shown, the first plurality of light planes 212B includes five light planes 212B which resolves as a corresponding five light lines 222B on the surface 112; however, in other embodiments, the first plurality of light planes 212B may comprise anywhere between two and 200 light planes, but may not be the same number as the second plurality of light planes 214. Further, in the embodiment shown, each first inter-beam angle 252B (not shown) between each two adjacent light planes 212B are substantially identical, which generates the corresponding first multiline pattern 232B having the first plurality of light lines 222B which are equidistant from each other (shown in FIG. 10A). However, the first inter-beam angle 252B may be approximately 6.52°, forming the first projector span 262B of approximately 27°. In other embodiments, the first inter-beam angle 252B between different ones of the light planes 212B may range between approximately 0.1° and approximately 5°, but may not be the same as the second inter-beam angle 254 between different ones of the second plurality of light planes 214.

To generate the interleaved pattern 231B shown in FIG. 10C, the first and second projector origins 242 and 244 of the first and second projectors 202 and 204 may be offset by a projector offset angle 318B (not shown). The projector offset angle 318B may also be a function of at least one of a number of projectors in the set of projectors 104, the first inter-beam angle 252B between the light planes 212B projected by the first projector 202 or the second inter-beam angle 254 between light planes 214 projected by the second projector 204. In the embodiments where the first and second inter-beam angles 252B and 254 are different, the projector offset angle 318B may be a function of a smaller angle of the first and second inter-beam angles 252B and 254. For example, to avoid overlap between a light line of the first plurality of light lines 222B and a light line of the second plurality of light lines 224, the projector offset angle 318 is typically not 0%, 100%, or a multiple of 100% (e.g., 200%, 300%, 400%, etc.) of the smaller second inter-beam angle 254. In the embodiment shown in FIGS. 10A-10C, the first and second inter-beam angles 252B and 254 are approximately 6.52° and 3.26° respectively, and the projector offset angle 318 may be approximately 1.6° (being ½ of the smaller second inter-beam angle 254). In other embodiments, the projector offset angle 318B may range between 0% and 9/10 of the second inter-beam angle 254.

The above combination of projector offset angle 318B relative to the first and second inter-beam angles 252B and 254 may generally position at least one light line 222B projected by the first projector 202 between (still referred to as interleaved between) two light lines 224 projected by the second projector 204; similarly at least one light line 224 projected by the second projector 204 may be positioned between (still referred to as interleaved) two light lines 222B projected by the first projector 202. However, due to the difference between the first and second inter-beam angles 252B and 254 and the difference between the number of the first and second light lines 222B and 224, multiple light lines 224 projected by the second projector 204 may be positioned between two light lines 222B projected by the first projector 202, such that some light lines 224 (although still positioned between two light lines 222B) are immediately adjacent a light line 224 projected by the same second projector 204. In the embodiment shown in FIG. 10C, two light lines 224 projected by the second projector 204 are positioned between two light lines 222B projected by the first projector 202. However, in other embodiments, a different number of multiple light lines projected by one projector of a set of projectors may be positioned between two light lines projected by another projector of the set of projectors. This results in the final interleaved pattern 231B having some equidistant light lines 222B and 224, but some clustered light lines 222B and 224 as shown in FIG. 10C when the first and second multiline patterns 232B and 234 are concurrently projected. The resulting interleaved pattern 231B may be denser than the first and second multiline patterns 232B and 234.

### Fourth Embodiment of Interleaved Pattern 231C

Another embodiment of a top interleaved pattern 231C formed from a combination of a first multiline pattern 232B and a second multiline pattern 234C is shown in FIGS. 11A-11C. Referring to FIG. 11A, the first plurality of light planes 212B projected by the first projector 202 resolving as the first multiline pattern 232B including the first plurality of light lines 222B on the surface 112 may be the same as that described in FIG. 10A. Specifically, the first projector 202 projects five light planes 212B which resolves as a corresponding five light lines 222B on the surface 112. The first inter-beam angle 252B as between each light plane 212B of the first plurality of light planes 212B is approximately 6.25°.

However, as described above, in some embodiments, the first and second inter-beam angles 252 and 254 between different light planes 212 (i.e., within the first plurality of light planes 212) or 214 (i.e., within the second plurality of light planes 214) may be different, and the number of light planes projected by the first and second projectors 202 and 204 may be different. Referring to FIG. 11B, the second projector 204 projects a second plurality of light planes 214C (not shown) which resolves as a second multiline pattern 234C including a second plurality of light lines 224C on the surface 112. In the embodiment shown, the second plurality of light planes 214C includes 10 light planes 214C which resolves as a corresponding 10 light lines 224C on the surface 112; however, in other embodiments, the second plurality of light planes 214C may comprise anywhere between two and 200 light planes. Further, in the embodiment shown in FIG. 11, a second inter-beam angle 254C (not shown) as between different ones of the plurality of light planes 214C are different, which generates the corresponding second multiline pattern 234C having some light lines 224C which are clustered together and some light lines 224C which are further apart (shown in FIG. 11B). The second inter-beam angle 254C as between the first and second, third and fourth, fifth and sixth, seventh and eighth and ninth and tenth light planes 214C may be approximately 1.63°, which resolves as the first and second, third and fourth, fifth and sixth, seventh and eighth, and ninth and tenth light lines 224C being closer together on the surface 112. In contrast, the second inter-beam angle 254C as between the second and third, the fourth and fifth, and the sixth and seventh light, and the eighth and ninth planes 214C may be approximately 3.26°, which resolves as the second and third, fourth and fifth and six and seventh light lines 224C being further apart on the surface 112. As a result, a corresponding second projector span 264C is approximately 23°.

To generate the interleaved pattern 231C (shown in FIG. 11C), the first and second projector origins 242 and 244 of the first and second projectors 202 and 204 may be offset by a projector offset angle 318C (not shown). In the embodiment shown in FIGS. 11A-11C, the projector offset angle 318C may be approximately 1.63°. This combination of projector offset angle 318C relative to the first and second inter-beam angles 252B and 254C may generally position at least one light line 222B projected by the first projector 202 between (still referred to as interleaved between) two light lines 224C projected by the second projector 204; similarly at least one light line 224C projected by the second projector 204 may be positioned between (still referred to as interleaved) two light lines 222B projected by the first projector 202. However, due to the difference between the first and second inter-beam angles 252B and 254C and the variation in the second inter-beam angle 254C between different light planes 214C, multiple light lines 224C projected by the second projector 204 may be positioned between two light lines 222B projected by the first projector 202, such that some light lines 224C (although still positioned between two light lines 222B projected by the first projector 202) are immediately adjacent a light line 224C projected by the same second projector 204. In the embodiment shown in FIG. 11C, two light lines 224C projected by the second projector 204 are positioned between two light lines 222B projected by the first projector 202. Additionally, due to the difference between the first and second inter-beam angles 252B and 254C and the variation in the second inter-beam angle 254C, this results in the final interleaved pattern 231C having substantially equidistant light lines 222B and 224C (shown in FIG. 11C) when the first and second multiline patterns 232B and 234 are concurrently projected. The resulting interleaved pattern 231C may be denser than the first and second multiline patterns 232B and 234C, and may also be larger (e.g. have a larger projector span) than the first and second multiline patterns 232B and 234C (e.g., due to the terminal light lines 222Bₜ and 224Cₜ).

### Fifth Embodiment of Interleaved Pattern 231D

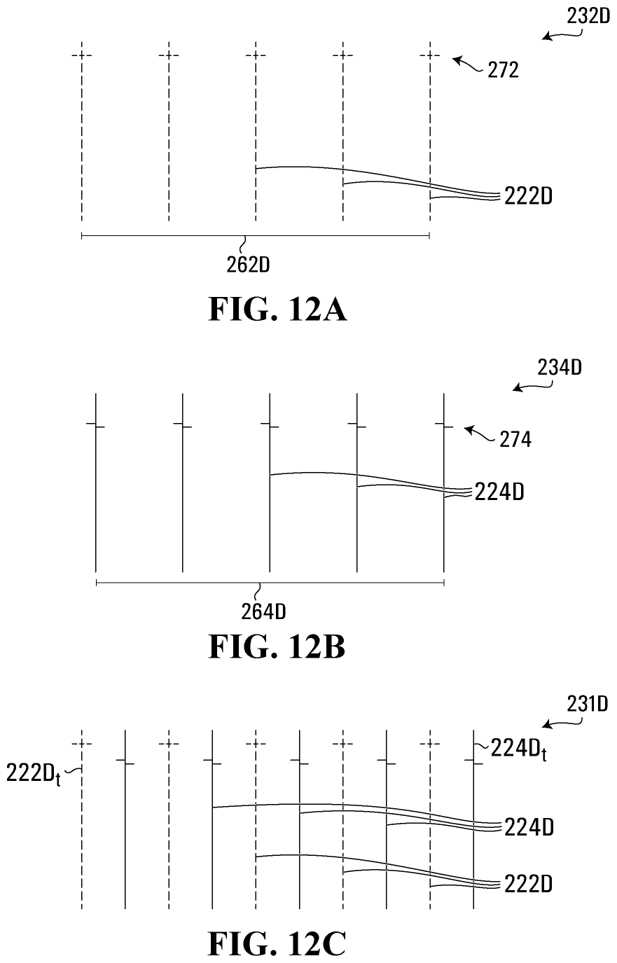

Another embodiment of a top interleaved pattern 231D formed from a combination of a first multiline pattern 232D and a second multiline pattern 234D is shown in FIGS. 12A-12C.

Referring to FIG. 12A, the first projector 202 projects a first plurality of light planes 212D (not shown) which resolves as the first multiline pattern 232D including the first plurality of light lines 222D on the surface 112. In the embodiments shown, the first plurality of light planes 212D includes five light elements (e.g., the light planes 212D) which resolves as the corresponding five light lines 222D on the surface 112. However, in other embodiments, the first projector 202 may project a different number of light elements, and may project anywhere between two and 200 light elements. Each light line of the light lines 222D incorporates a respective discrete coded element 272 extending therefrom. In the embodiment shown, each discrete coded element 272 are of a same type (e.g., a left protrusion and a right protrusion which are aligned relative each other along the light line 222D). However, in other embodiments, the discrete coded elements 272 extending from different light lines of the first plurality of light lines 222D may be of different types (e.g., each discrete coded element 272 may be of a different type and/or may be located at different positions along the light line 222D) and/or the discrete coded elements 272 extending from each light line of the light lines 222D may be of a type different than the aligned left and right protrusions shown in FIG. 12A. The discrete coded elements 272 may be generated using a pattern generator incorporated into the first projector 202; the manner of generating the discrete coded elements 272 and 274 (described below) and different types and configurations of discrete coded elements 272 and 274 are described in related international patent application no. PCT/CA2022/050804 titled “3D SCANNER WITH STRUCTURED LIGHT PATTERN PROJECTOR AND METHOD OF USING SAME FOR PERFORMING LIGHT PATTERN MATCHING AND 3D RECONSTRUCTION”, which is incorporated by reference in its entirety herein.

In the embodiment shown in FIG. 12A, a first inter-beam angle 252D (not shown) between each of the light planes 212D are substantially identical, which may generate the first multiline pattern 232D formed of the light lines 222D which are substantially equidistant to each other (shown in FIG. 12A). The first inter-beam angles 252D may be approximately 3°, forming a first projector span 262D of approximately 12°. However, in other embodiments, the first inter-beam angles 252D may be different between different light planes 212D of the first plurality of light planes 212D (similar to the configuration shown in FIG. 11B), and/or may range between approximately 0.1° and approximately 5°.

Referring to FIG. 12B, the second projector 204 projects a second plurality of light planes 214D (not shown) which resolves as the second multiline pattern 234D including a second plurality of light lines 224D on the surface 112. In the embodiment shown, the second plurality of light planes 214D includes five light elements (e.g., the light planes 214D) which resolves as a corresponding five light lines 224D on the surface 112. However, in other embodiments, the second projector 204 may project a different number of light elements, and may project anywhere between two and 200 light elements. Each light line of the light lines 224D incorporates a respective discrete coded element 274 extending therefrom. In the embodiment shown, each discrete coded element 274 are of a same type (e.g., an upper left protrusion and a lower right protrusion which are slightly offset relative each other along the light line 224D). However, in other embodiments, the discrete coded elements 274 extending from different light lines of the light lines 224D may be of different types (e.g., each discrete coded element 274 may be of a different type and/or may be located at different positions along the light line 224D) and/or the discrete coded elements 274 extending from each light line of the light lines 224D may be of a type different than the offset upper left and lower right protrusions shown in FIG. 12B. The discrete coded elements 274 may be generated using a pattern generator incorporated into the second projector 204.

Further, in the embodiment shown, the discrete coded elements 274 extending from the second plurality of light lines 224D (shown in FIG. 12B) are of a different type than the discrete coded elements 272 extending from the light lines 222D (shown in FIG. 12A). Use of different types of discrete coded elements 272 and 274 may aid in distinguishing the light lines 222D projected by the first projector 202 from the light lines 224D projected by the second projector 204, which may assist in feature matching as between different images of a frame captured by the at least one camera 102 of the scanner 100. However, in other embodiments, the discrete coded elements 274 extending from the light lines 224D and the discrete coded elements 272 extending from the light lines 222D may be of a same type.

In the embodiment shown in FIG. 12B, a second inter-beam angle 254D (not shown) between each of the light planes 214D are substantially identical, which may generate the second multiline pattern 234D formed of the light lines 224D which are substantially equidistant to each other. The second inter-beam angles 254D may be approximately 3°, forming a first projector span 264D of approximately 12°. However, in other embodiments, the second inter-beam angles 254D may be different between different light planes 214D of the second plurality of light planes 214D (similar to the configuration shown in FIG. 11B), and/or may range between approximately 0.1° and approximately 5°.

To generate the interleaved pattern 231D shown in FIG. 12C, the first and second projector origins 242 and 244 of the first and second projectors 202 and 204 may be offset by a projector offset angle 318D (not shown). Similar to the projector offset angle 318 (shown in FIG. 7), the projector offset angle 318D may be a function of at least one of a number of projectors in the set of projectors 104, the first inter-beam angle 252D between the light planes 212D projected by the first projector 202 or the second inter-beam angle 254D between the light planes 214D projected by the second projector 204. In the embodiment shown in FIGS. 12A-12C, the first and second inter-beam angles 252D and 254D are substantially identical and are both 3° and the set of projectors 201 includes two projectors 202 and 204. The projector offset angle 318D may thus be approximately 1.5° (being ½ of the first and second inter-beam angles 252D and 254D of 3°). This results in a final interleaved pattern 231D having substantially equidistant light lines 222D and 224D as shown in FIG. 12C when the first and second multiline patterns 232D and 234D are concurrently projected. The final interleaved pattern 231D is denser than the first and second multiline patterns 232D and 234D and is also larger (e.g., due to the terminal light lines 222Dₜ and 224Dₜ) than the first and second multiline patterns 232D and 234D.

In other embodiments, the projector offset angle 318D may range between 1/10 and 9/10 of the first and second inter-beam angles 252D and 254D. In yet other embodiments, the projector offset angle 318D may be more than 100% of the first and second inter-beam angles 252D and 254D. Where the projector offset angle 318 is a percentage more than approximately 100% of the first and second inter-beam angles 252D and 254D, some light lines projected by one projector may be immediately adjacent light lines projected by the other projector, whereas other lines projected by the one projector may instead be immediately adjacent light lines projected by a same projector. The resulting interleaved pattern (not shown) may be larger than the first and second multiline patterns 232D and 234D, may be denser in a middle where the first and second multiline patterns 232 and 234 are interleaved, but may be of same density at respective peripheries where the first and second multiline patterns 232D and 234D are not interleaved.

### Second Embodiment of Set of Projectors 201A

A set of projectors 201A in accordance with another embodiment is shown in FIGS. 13-15 and 16A-16D. The set of projectors 201A may include the first projector 202, the second projector 204 and at least one further projector. Only a third projector 205 is shown in FIGS. 13-15 and 16A-16D for clarity; however, those skilled in the art would recognize that the description below may be similarly applicable to a set of projectors including more than one further projector (such as a fourth projector, a fifth projector, a sixth projector, and a nth projector, etc.)

Referring to FIG. 13, the first, second and third projectors 202, 204 and 205 are mounted to the housing 106 aligned along a baseline 310A. In the embodiment shown, the baseline 310A is at an hd angle 316A relative to the hd scanner plane defined by the height and depth axes 300 and 302 of the scanner 100 and is at an wd angle 314A relative to the wd scanner plane defined by the width and depth axes 304 and 302. In the embodiment shown, the hd angle 316A is approximately 15°; however, in other embodiments, the hd angle 316A may range between approximately 0° (i.e., substantially parallel to the hd scanner plane) and 90°. Further, in the embodiment shown, the wd angle 314A is approximately 30°; however, in other embodiments, the wd angle 314A angle may range between approximately 0° (i.e., substantially parallel to the wd scanner plane) and 90°.

The first projector origin 242 of the first projector 202 and the second projector origin 244 of the second projector 204 are separated by a first set separation distance 312A along the baseline. In the embodiment shown, the first set separation distance 312A is approximately 12 mm; however, in other embodiments, the first set separation distance 312A may range between approximately 5 mm and 50 mm. The second projector origin 244 and a third projector origin 245 of the third projector 205 are separated by a second set separation distance 313 along the baseline 310A. In the embodiment shown in FIG. 13, the second set separation distance 313 is approximately 12 mm; however, in other embodiments, the second set separation distance 313 may range between approximately 5 mm and 50 mm. In embodiments where the set of projectors 201A includes more than one further projector (such as a fourth projector, a fifth projector, a sixth projector, a nth projector, etc.), the corresponding origin of each further projector may be separated from an origin of a previous projector by a further separation distance.

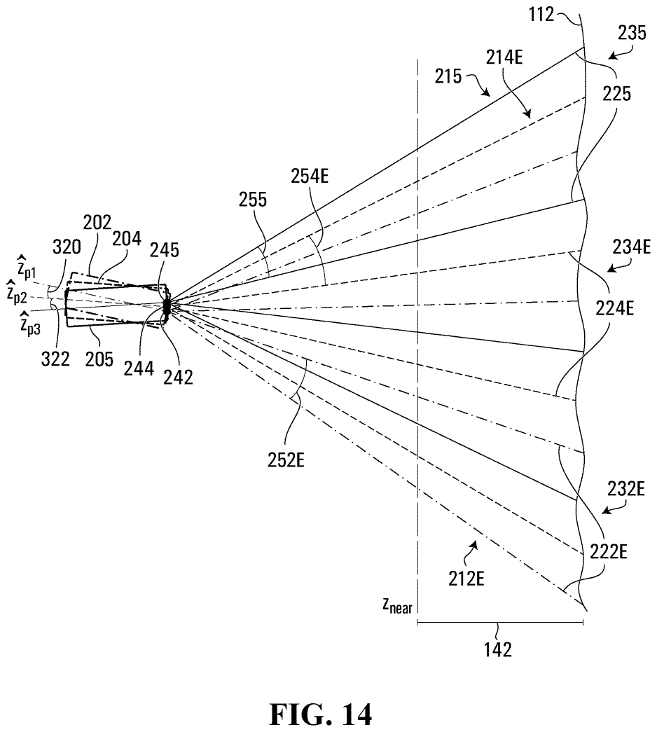

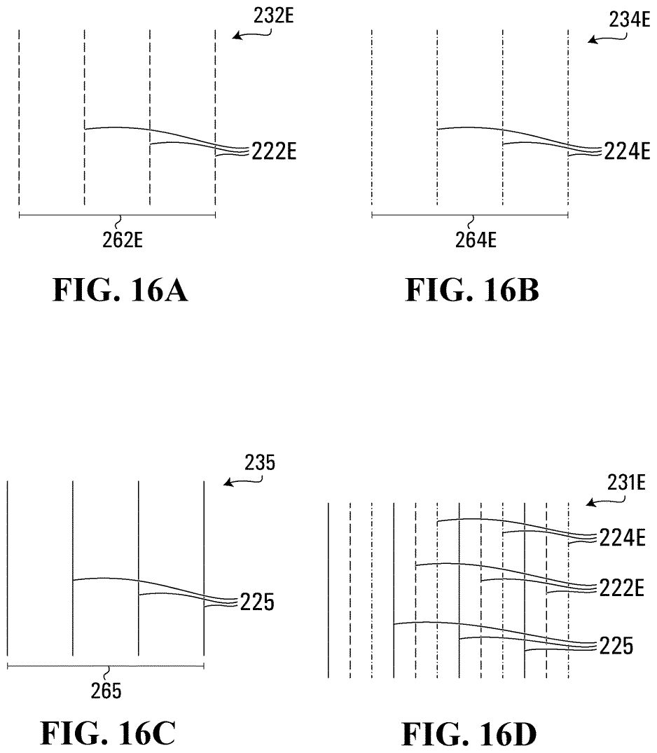

Referring now to FIGS. 14 and 16A-16C, the first projector 202, the second projector 204, and the third projector 205 are all multiline projectors in the embodiment shown. The first projector 202 projects a first plurality of light planes 212E resolving as a first multiline pattern 232E including a first plurality of light lines 222E (best seen in FIG. 16A) on the surface 112. The second projector 204 projects a second plurality of light planes 214E resolving as a second multiline pattern 234E including a second plurality of light lines 224E (best shown in FIG. 16B) on the surface 112. The third projector 205 projects a third plurality of light planes 215 resolving as a third multiline pattern 235 including the third plurality of light lines 225 (best shown in FIG. 16C) on the surface 112. In the embodiment shown, the first plurality of light planes 212E projected by the first projector 202, the second plurality of light planes 214E projected by the second projector 204 and the third plurality of light planes 215 projected by the third projector 205 are substantially identical and each comprise four light planes; however, in other embodiments, the first, second and third plurality of light planes 212E, 214E and 215 may each comprise anywhere between two and 200 light planes, and may each comprise three light planes, five light planes, seven light planes, nine light planes, 15 light planes, 19 light planes, 33 light planes, 59 light planes, 65 light planes, or 99 light planes for example.

In the embodiment shown, the first plurality of light planes 212E may comprise non-intersecting light planes and each light plane 212E may be separated from an adjacent light plane 212E by a first inter-beam angle 252E (shown in FIG. 14). In the embodiment shown, each first inter-beam angle 252E between each two adjacent light planes 212E are substantially identical and is approximately 3°, generating the corresponding first multiline pattern 232E having the first plurality of light lines 222E which are equidistant from each other (shown in FIG. 16A) and a first projector span 262E of approximately 9°. However, in other embodiments, the first inter-beam angle 252E between different ones of the light planes 212E may be different (similar to embodiments described above in association with FIG. 11B) and/or may range between approximately 0.1° and approximately 5° (similar to the embodiments described above in association with FIGS. 10A, 11A and 11B).

Similarly, the second plurality of light planes 214E may also comprise non-intersecting light planes and each light plane 214E may be separated from an adjacent light plane 214E by a second inter-beam angle 254E (shown in FIG. 14). In the embodiment shown, each second inter-beam angle 254E between each two adjacent light planes 214E are substantially identical and is approximately 3°, generating the corresponding second multiline pattern 234E having the second plurality of light lines 224E which are equidistant from each other and a second projector span 264E of approximately 9° (shown in FIG. 16B). However, in other embodiments, the second inter-beam angle 254E between different ones of the light planes 214E may be different (similar to the embodiment described in association with FIG. 11B), may range between approximately 0.1° and approximately 5° (similar to the embodiment described above in association with FIGS. 10A, 11A and 11B) and/or may be different from the first inter-beam angle 252E (similar to the embodiment described above in association with FIGS. 10A and 10B).

Further, the third plurality of light planes 215 may also comprise non-intersecting light planes and each light plane 215 may be separated from an adjacent light plane 215 by a third inter-beam angle 255 (shown in FIG. 14). In the embodiment shown, each third inter-beam angle 255 between each two adjacent light planes 215 are substantially identical and is approximately 3°, generating the corresponding third multiline pattern 235 having the third plurality of light lines 225 which are equidistant from each other and a third projector span 265 of approximately 9° (shown in FIG. 16C). However, in other embodiments, the third inter-beam angle 255 between different ones of the light planes 215 may be different (similar to the embodiment described above in association with FIG. 11B), may range between approximately 0.1° and approximately 5° (similar to the embodiment described above in association with FIGS. 10A, 11A and 11B) and/or may be different from the first and second inter-beam angles 252E and 254E (similar to the embodiment described above in association with FIGS. 10A and 10B).

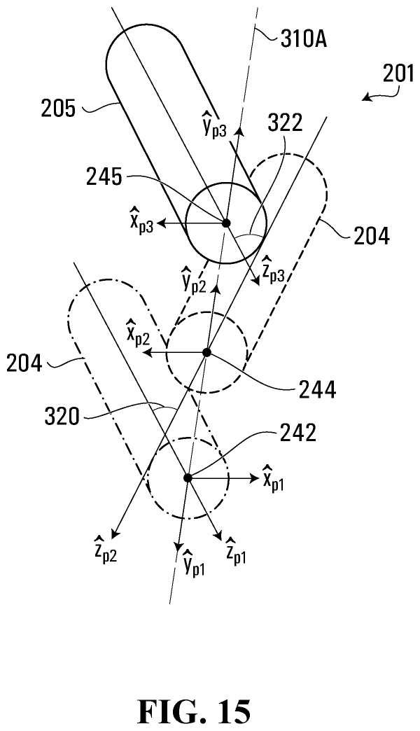

Referring to FIGS. 14 and 15, in the embodiment shown, the first projector 202 is mounted to the housing 106 with the first projector origin 242 positioned at the first projector orientation

$$( {O}_{p 1} = [ \begin{matrix}{\hat{x}}_{p 1} \\ {\hat{y}}_{p 1} \\ {\hat{z}}_{p 1}\end{matrix} ] ) ,$$

the second projector 204 is mounted to the housing 106 with the second projector origin 244 positioned at the second projector orientation

$$( {O}_{p 2} = [ \begin{matrix}{\hat{x}}_{p 2} \\ {\hat{y}}_{p 2} \\ {\hat{z}}_{p 2}\end{matrix} ] ) ,$$

and the third projector 205 is mounted to the housing 106 with the third projector origin 245 positioned at a third projector orientation

$${O}_{p 3} = [ \begin{matrix}{\hat{x}}_{p 3} \\ {\hat{y}}_{p 3} \\ {\hat{z}}_{p 3}\end{matrix} ] .$$

The first, second and third projector orientations Oₚ₁, Oₚ₂ and Oₚ₃ may be positioned such that the first and second projector origins 242 and 244 are offset by a first projector offset angle 320, and the second and third projector origins 244 and 245 are offset by a second projector offset angle 322. The first and second projector offset angles 320 and 322 may be configured relative to the first, second and third inter-beam angles 252E, 254E and 255 such that the first multiline pattern 232E projected by the first projector 202, the second multiline pattern 234E projected by the second projector 204 and the third multiline pattern 235 projected by the third projector 205 may be combined into the interleaved pattern 231E (shown in FIG. 16D) when projected concurrently. More specifically, the first and second projector offset angles 320 and 322 may be configured relative to the first, second and third inter-beam angles 252E, 254E and 255 such that one light line of the first plurality of light lines 222E forming the first multiline pattern 232E is projected onto the surface 112 between (also referred to as interleaved between) two light lines of the second plurality of light lines 224E forming the second multiline pattern 234E and between (also referred to as interleaved between) two light lines of the third plurality of light lines 225 forming the third multiline pattern 235 to generate the interleaved pattern 231E. Further, the first and second projector offset angles 320 and 322 may be configured relative to the first, second and third inter-beam angles 252E, 254E and 255 such that a light plane 212E projected by the first projector 202 defining the one light line 222E of the first multiline pattern 232E, two light planes 214E projected by the second projector 204 defining the two light lines 224E of the second multiline pattern 234E and two light planes 215 projected by the third projector 205 defining the two light lines 225 of the third multiline pattern 235 is non-intersecting throughout the scanner DOF 142. In some embodiments, the light plane 212E defining the one light line 222E, the two light planes 214E defining the two light lines 224E and the two light planes 215 defining the two light lines 225 may be non-intersecting throughout an entire projection depth of the first, second and third projectors 202, 204 and 206 and/or non-intersecting throughout a scanning volume of the 3D scanner 100.

In the embodiment shown, the first projector offset angle 320 may be an offset between the yzₚ₁ first projector plane and the yzₚ₂ second projector (shown in FIG. 15). The second projector offset angle 322 may be an offset between a yzₚ₃ third projector plane defined by the third projector ŷₚ₃ axis and the third projector \hat{z}ₚ₃ axis relative to the yzₚ₂ second projector plane (shown in FIG. 15). Aligning the first, second and third projector origins 242, 244 and 245 along the baseline 310A while offsetting the yzₚ₁ first projector plane, the yzₚ₂ second projector plane and the yzₚ₃ third projector plane by the first and second projector offset angles 320 and 322 may enable the first plurality of light planes 212E projected by the first projector 202, the second plurality of light planes 214E projected by the second projector 204 and the third plurality of light planes 215 projected by the third projector to be non-intersecting throughout the scanner DOF 142 (and/or throughout the entire projection depth of the first, second and third projectors 202, 204 and 205) when the first, second and third plurality of light planes 212E, 214E and 215 are projected concurrently. In other embodiments, the xyₚ₁ first projector plane may be offset by the first projector offset angle 320 relative to the xyₚ₂ second projector plane (not shown); and a xyₚ₃ third projector plane defined by the third projector ŷₚ₃ axis and the third projector \hat{x}ₚ₃ axis may be offset by the second projector offset angle 322 relative to the xyₚ₂ second projector plane (not shown). In yet other embodiments, the xzₚ₁ first projector plane may be offset by the first projector offset angle 320 relative to the xzₚ₂ second projector plane (not shown); and a xzₚ₃ third projector plane defined by the third projector \hat{x}ₚ₃ axis and the third projector \hat{z}ₚ₃ axis may be offset by the second projector offset angle 322 relative to the xzₚ₂ second projector plane (not shown). In embodiments where the set of projectors 201A includes more than one further projector (such as a fourth projector, a fifth projector, a sixth projector, a nth projector, etc.), the corresponding origin of each further projector may be offset from an origin of a previous projector by a further offset angle.

The first and second projector offset angles 320 and 322 may be a function of at least one of a number of projectors in the set of projectors 201, the first inter-beam angle 252E, the second inter-beam angle 254E or the third inter-beam angle 255. In embodiments where the first, second and third inter-beam angles 252E, 254E and 255 are substantially identical, the first and second projector offset angles 320 and 322 may be

$$\frac{1}{n}$$

of the first, second and third inter-beam angles 252E, 254E and 255, wherein n is the number of projectors in the set of projectors 201. For example, in the embodiment shown in FIGS. 14 and 16A-16D, the first, second and third inter-beam angles 252E, 254E and 255 are substantially identical and are all 3° and the set of projectors 201 includes three projectors 202, 204 and 205, the first and second projector offset angles 320 and 322 may be approximately 1° (being ⅓ of the first, second and third inter-beam angles 252E, 254E and 255 of 1.5°). In embodiments where the set of projectors 201A includes more than one further projector (such as a fourth projector, a fifth projector, a sixth projector, a nth projector, etc.), the projector offset angles may be a function of the inter-beam angles and the number of projectors in the set of projectors 201A. For example, in embodiments where the set of projectors 201A includes four projectors, the projector offset angles may be approximately ¼ of the inter-beam angles, in embodiments including five projectors, the projector offset angles may be approximately being ⅕ of inter-beam angles, etc. However, in other embodiments, the first and second projector offset angles 320 and 322 may range between 1/10 and 9/10 of the first, second and third inter-beam angles 252E, 254E and 255. In yet other embodiments, the first and second projector offset angles 320 and 322 may be more than approximately 100% of the first, second and third inter-beam angles 252E, 254E and 255.

The above combination of first and second projector offset angles 320 and 322 relative to the first, second and third inter-beam angles 252E, 254E and 255 may generally position at least one light line 222E projected by the first projector 202 immediately adjacent and equidistant between (also referred to as interleaved between) one light line 224E projected by the second projector 204 and one light line 225 projected by the third projector 205 in the interleaved pattern 231E. Similarly, at least one light line 224E projected by the second projector 204 may be positioned immediately adjacent and equidistant between (also referred to as interleaved between) one light line 222E projected by the first projector 202 and one light line 225 projected by the third projector 205 in the interleaved pattern 231E. Further, at least one light line 225 projected by the third projector 205 may be positioned immediately adjacent and equidistant between (also referred to as interleaved between) one light line 222E projected by the first projector 202 and one light line 224E projected by the second projector 204 in the interleaved pattern 231E.

In other words, in the final interleaved pattern 231E (best shown in FIG. 16D), each line projected by one projector is immediately adjacent another line projected by another projector and the light lines 222E, 224E and 225 are substantially equidistant when the first, second and third multiline patterns 232E, 234E and 235 are concurrently projected. The final interleaved pattern 231E is denser than the first, second and third multiline patterns 232E, 234. However, in other embodiments (similar to the embodiments described above in association with FIGS. 10C and 11C), more than one line projected by one projector may be immediately adjacent another line projected by the same projector (but still positioned between lines projected by other projectors), depending on variations in the first and second projector offset angles 320 and 322 relative to the first, second and third inter-beam angles 252E, 254E and 255. In embodiments where the set of projectors 201A includes more than one further projector (such as a fourth projector, a fifth projector, a sixth projector, a nth projector, etc.), corresponding lines of the further projector may be positioned between a line of a first different projector and a line of a second different projector. Representations of the final interleaved pattern 231E (or portion thereof) reflected on the surface 112 may be included in the images of the surface 112 captured by at least one of the first and second cameras 120 and 130 and may be transmitted to the processor circuit 103. The processor circuit 103 may utilize the representations of the combined interleaved pattern 231E in the images (and as distorted in the images by contours of the surface 112 for example) to assist in determining 3D measurements of the surface 112.

### Third Embodiment of Set of Projectors 201B

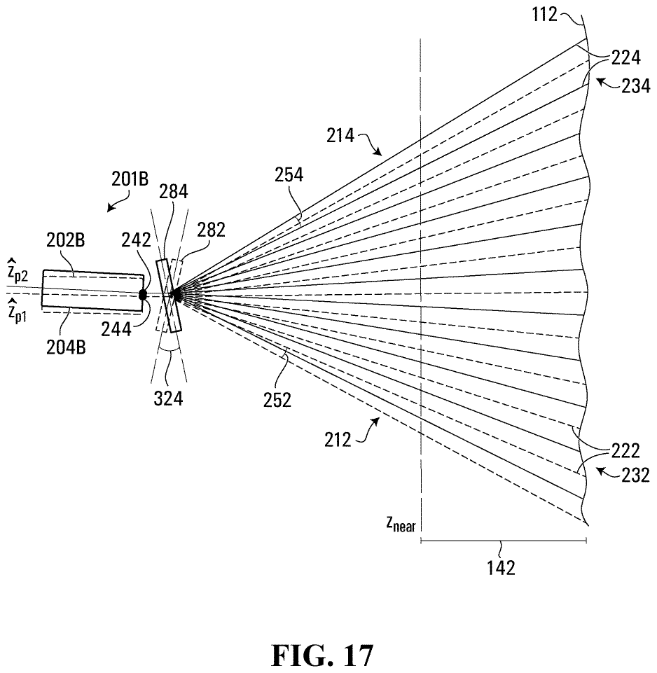

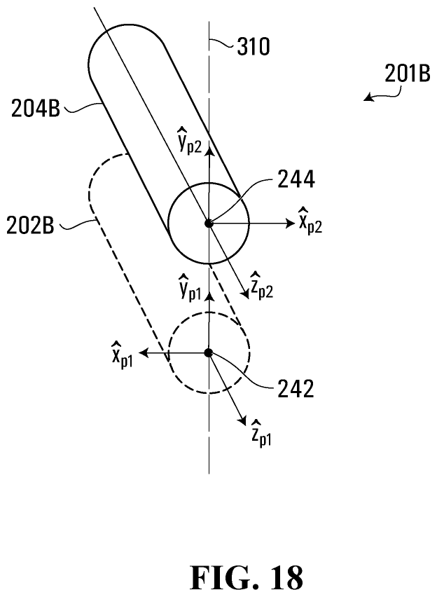

A set of projectors 201B in accordance with another embodiment is shown in FIGS. 17 and 18. The set of projectors 201B may include a first projector 202B the second projector 204B. The first projector 202B may be substantially similar to the first projector 202 described above in association with FIGS. 5-7 and 8A-8C, and may project the first plurality of light planes 212 having the first inter-beam angle 252 and resolving as the first multiline pattern 232 including a first plurality of light lines 222 (shown in FIG. 8A) on the surface 112. However, the first projector 202B may include an optical element 282 configured to adjust an angle of projection of the first plurality of light planes 212 similar to how an adjustment of a first projector 2, axis would adjust the angle of projection of the first plurality of light planes 212. Similarly, the second projector 204B may be substantially similar to the second projector 204 described above in association with FIGS. 5-7 and 8A-8C, and may project the second plurality of light planes 214 having the second inter-beam angle 254 and resolving as the second multiline pattern 234 including the second plurality of light lines 224E (shown in FIG. 8B) on the surface 112. However, the second projector 204B may similarly include an optical element 284 configured to adjust an angle of projection of the second plurality of light planes 214 similar to how an adjustment of a second projector \hat{z}ₚ₂ axis would adjust the angle of projection of the second plurality of light planes 214.

Referring to FIGS. 17 and 18, in the embodiment shown, the first projector 202B is mounted to the housing 106 with the first projector origin 242 positioned at a first projector orientation

$$( {O}_{p 1} = [ \begin{matrix}{\hat{x}}_{p 1} \\ {\hat{y}}_{p 1} \\ {\hat{z}}_{p 1}\end{matrix} ] )$$

and the second projector 204B is mounted to the housing 106 with the second projector origin 244 positioned at a second projector orientation

$$( {O}_{p 2} = [ \begin{matrix}{\hat{x}}_{p 2} \\ {\hat{y}}_{p 2} \\ {\hat{z}}_{p 2}\end{matrix} ] ) .$$

The first and second projector orientations Oₚ₁ and Oₚ₂ may be positioned such that the first and second projector origins 242 and 244 are aligned. However, a relative arrangement of the first and second optical elements 282 and 284 may implement a projector offset angle 324. The projector offset angle 324 may be implemented without any offset between the yzₚ₁ first projector plane and the yzₚ₂ second projector plane (shown in FIG. 18).

The projector offset angle 324 may be configured relative to the first inter-beam angle 252 and the second inter-beam angle 254, such that the first multiline pattern 232 projected by the first projector 202 and the second multiline pattern 234 projected by the second projector 204 may be combined into the top interleaved pattern 231 (shown in FIG. 8C) when projected concurrently. More specifically, the relative arrangement of the first and second optical elements 282 and 284 may implement the projector offset angle 324 relative to the first and second inter-beam angles 252 and 254 such that one light line of the first plurality of light lines 222 forming the first multiline pattern 232 is projected onto the surface 112 between (also referred to as interleaved between) two light lines of the second plurality of light lines 224 forming the second multiline pattern 234 to generate the top interleaved pattern 231. Further, the relative arrangement of the first and second optical elements 282 and 284 may implement the projector offset angle 324 relative to the first and second inter-beam angles 252 and 254, such that a light plane 212 projected by the first projector 202 defining the one light line 222 of the first multiline pattern 232 and two light planes 214 projected by the second projector 204 defining the two light lines 224 of the second multiline pattern 234 is non-intersecting throughout the scanner DOF 142. In some embodiments, the light plane 212 defining the one light line 222 and the two light planes 214 defining the two light lines 224 may be non-intersecting throughout an entire projection depth of the first and second projectors 202 and 204 and/or non-intersecting throughout a scanning volume of the 3D scanner 100.

Similar to the projector offset angle 318, the projector offset angle 324 may also be a function of at least one of a number of projectors in the set of projectors 201A, the first inter-beam angle 252 or the second inter-beam angle 254. In embodiments where the first and second inter-beam angles 252 and 254 are substantially identical, the projector offset angle 324 may be

$$\frac{1}{n}$$

of the first and second inter-beam angles 252 and 254, wherein n is the number of projectors in the set of projectors 201A. For example, in the embodiment shown in FIGS. 17 and 18, the first and second inter-beam angles 252 and 254 are substantially identical and are both 3.26°, the set of projectors 201A includes two projectors, and the projector offset angle 324 may be approximately 1.6° (being approximately ½ of the first and second inter-beam angles 252 and 254 of 3.26°).

The above combination of projector offset angle 324 relative to the first and second inter-beam angles 252 and 254 may generally position at least one light line 222 projected by the first projector 202 immediately adjacent and equidistant between (also referred to as interleaved between) two light lines 224 projected by the second projector 204 in the interleaved pattern 231 (shown in FIG. 8C); similarly at least one light line 224 projected by the second projector 204 may be positioned immediately adjacent and equidistant between (also referred to as interleaved between) two light lines 222 projected by the first projector 202 in the interleaved pattern 231 (again, shown in FIG. 8C). This results in the final interleaved pattern 231 having substantially equidistant light lines 222 and 224 as shown in FIG. 8C when the first and second multiline patterns 232 and 234 are concurrently projected. The final interleaved pattern 231 is denser than the first and second multiline patterns 232 and 234. Additionally, as a result of the terminal light lines 222ₜ and 224ₜ, the interleaved pattern 231 may also be larger (e.g., have a larger projector span) when compared to the first and second multiline patterns 232 and 234.

### Fourth Embodiment of a Set of Projectors 201C

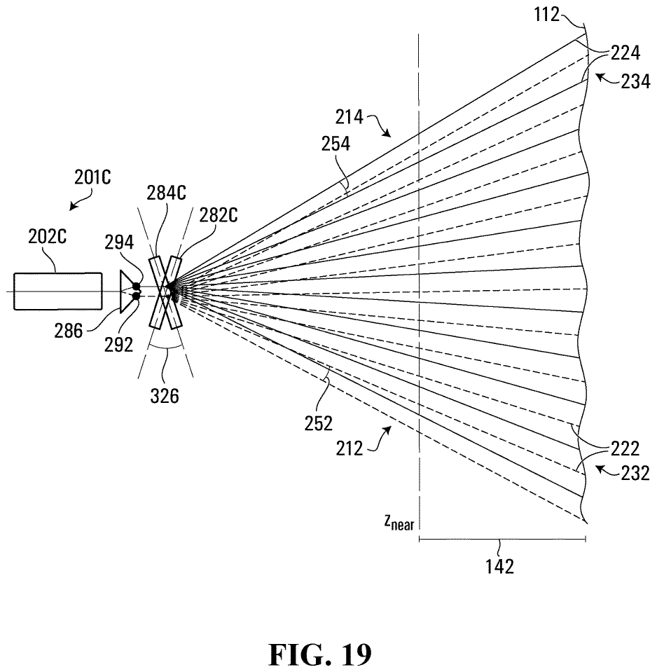

A set of projectors 201C in accordance with another embodiment is shown in FIG. 19. The set of projectors 201C may include only a single first projector 202C. The first projector 202C may comprise a single light element projector coupled to a beam splitter 286. The beam splitter 286 may generally be configured to split the single light element into at least two light sub-elements exiting the beam splitter 286 at a first split origin 292 and a second split origin 294. The first and second split origins 292 and 294 may be separated by a separation distance (not shown) which may increase the factor C₆ of the set of projectors 201C. For example, the separation distance may range between approximately 5 mm and 50 mm.

The light sub-element exiting the beam splitter 286 at the first split origin 292 may strike a first optical element 282C and exit as the first plurality of light planes 212 having the first inter-beam angle 252 and resolving as the first multiline pattern 232 including a first plurality of light lines 222 (shown in FIG. 8A) on the surface 112. In this regard, the light sub-elements exiting at the first split origin 292 may comprise a multiline light sub-element (such as the first plurality of light planes 212). The first optical element 282C is configured to adjust an angle of projection of the first plurality of light planes 212. Similarly, light sub-element exiting the beam splitter 286 at the second split origin 294 may strike a second optical element 284C and exit as the second plurality of light planes 214 having the second inter-beam angle 254 and resolving as the second multiline pattern 234 including the second plurality of light lines 224E (shown in FIG. 8B) on the surface 112. In this regard, the light sub-element exiting at the second split origin 294 may comprise a multiline light sub-element (such as the second plurality of light planes 214) as well. The second optical element 284C is configured to adjust an angle of projection of the second plurality of light planes 214.

A relative arrangement of the first and second optical elements 282C and 284C may implement a projector offset angle 326. The projector offset angle 326 may be configured relative to the first inter-beam angle 252 and the second inter-beam angle 254, such that the first multiline pattern 232 and the second multiline pattern 234 may be combined into the top interleaved pattern 231 (shown in FIG. 8C). More specifically, the relative arrangement of the first and second optical elements 282C and 284C may implement the projector offset angle 326 relative to the first and second inter-beam angles 252 and 254 such that one light line of the first plurality of light lines 222 forming the first multiline pattern 232 is projected onto the surface 112 between (also referred to as interleaved between) two light lines of the second plurality of light lines 224 forming the second multiline pattern 234 to generate the top interleaved pattern 231. Further, the relative arrangement of the first and second optical elements 282 and 284 may implement the projector offset angle 326 relative to the first and second inter-beam angles 252 and 254, such that a light plane 212 defining the one light line 222 of the first multiline pattern 232 and two light planes 214 defining the two light lines 224 of the second multiline pattern 234 is non-intersecting throughout the scanner DOF 142. In some embodiments, the light plane 212 defining the one light line 222 and the two light planes 214 defining the two light lines 224 may be non-intersecting throughout an entire projection depth of the first and second projectors 202 and 204 and/or non-intersecting throughout a scanning volume of the 3D scanner 100.

The projector offset angle 326 may be a function of at least one of a number of split origins generated by the beam splitter 286, the first inter-beam angle 252 or the second inter-beam angle 254. In embodiments where the first and second inter-beam angles 252 and 254 are substantially identical, the projector offset angle 326 may be

$$\frac{1}{n}$$

of the first and second inter-beam angles 252 and 254, wherein n is the number of split origins generated by the beam splitter 286. For example, in the embodiment shown in FIG. 19, the first and second inter-beam angles 252 and 254 are substantially identical and are both 3.26°, the beam splitter 286 generates two split origins 292 and 294, and the projector offset angle 326 may be approximately 1.6° (being approximately ½ of the first and second inter-beam angles 252 and 254 of 3.26°).

The above combination of projector offset angle 326 relative to the first and second inter-beam angles 252 and 254 may generally position at least one light line 222 immediately adjacent and equidistant between (also referred to as interleaved between) two light lines 224 in the interleaved pattern 231 (shown in FIG. 8C); similarly at least one light line 224 may be positioned immediately adjacent and equidistant between (also referred to as interleaved between) two light lines 222 in the interleaved pattern 231 (again, shown in FIG. 8C). This results in the final interleaved pattern 231 having substantially equidistant light lines 222 and 224 as shown in FIG. 8C. The final interleaved pattern 231 is denser than the first and second multiline patterns 232 and 234. Additionally, as a result of the terminal light lines 222ₜ and 224ₜ, the interleaved pattern 231 may also be larger (e.g., have a larger projector span) when compared to the first and second multiline patterns 232 and 234.

### Bottom Set of Projectors 203

Referring back to FIG. 5, the first and second bottom projectors 206 and 208 of the bottom set of projectors 203 will now be briefly described. The first and second bottom projectors 206 and 208 are mounted to the housing 106 aligned along a baseline 330. In the embodiment shown, the baseline 330 is at an hd angle 336 relative to the hd scanner plane and is at an wd angle 334 relative to the wd scanner plane. In the embodiment shown, the hd angle 336 is approximately 15°; however, in other embodiments, the hd angle 336 may range between approximately 0° (i.e., substantially parallel to the hd scanner plane) and 90°. In the embodiment shown, the wd angle 334 is approximately −30°; however, in other embodiments, the wd angle 334 angle may range between approximately 0° (i.e., substantially parallel to the wd scanner plane) and 90°.

The first and second bottom projector origins 246 and 248 and are separated by a separation distance 332 along the baseline 330. In the embodiment shown, the separation distance 332 is the same as the set separation distance 312 and is approximately 12 mm; however, in other embodiments, the separation distance 332 may range between approximately 5 mm and 50 mm. Also similar to the set separation distance 312, the separation distance 332 between the first and second bottom projector origins 246 and 248 may increase the factor C₆ of the bottom set of projectors 203. For example, in the embodiment shown, the factor C₆ of the bottom set of projectors 203 may be approximately 15× more than the factor C₆ of a set of projectors which projects the interleaved pattern 239 using a single projector origin. In other embodiments, the separation distance 332 may increase the factor C₆ to anywhere between approximately 2× more and 50× more.

As described above, in the embodiment shown, the first and second bottom projectors 206 and 208 are both multiline projectors. The first bottom projector 208 projects the first bottom plurality of light planes 216 resolving as the first bottom multiline pattern 236 including the first plurality of light lines 226 on the surface 112. The second bottom projector 206 projects the second bottom plurality of light planes 216 resolving as the second bottom multiline pattern 236 including the second bottom plurality of light lines 226 on the surface 112. In the embodiment shown, the first and second bottom plurality of light planes 216 and 218 projected by the first and second bottom multiline patterns 236 and 238 are substantially the same as the first and second top plurality of light planes 212 and 214 projected as the first and second top multiline patterns 232 and 234 described above in association with FIGS. 6 and 8A-8C.

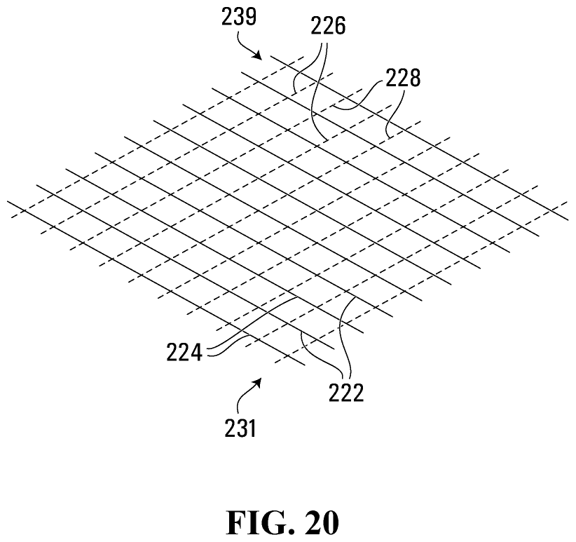

The first and second bottom multiline patterns 236 and 238 are designed and configured to be concurrently projected to form the bottom interleaved pattern 239. The bottom interleaved pattern 239 is substantially the same as the top interleaved pattern 231 (shown in FIG. 8C). In operation, the top and bottom interleaved patterns 231 and 239 may be projected at different time points. Additionally, due to the difference in the hd angle 336 and the wd angle 334 of the bottom baseline 330 as compared to the hd angle 316 and the wd angle 314 of the top baseline 310, the bottom interleaved pattern 239 and the top interleaved patterns 231 may be projected at an angle relative to each other to generate a grid configuration as shown in FIG. 20. However, as the top and bottom interleaved patterns 231 and 239 may be projected at the different time points, the grid configuration as shown in FIG. 20 may not be projected at any particular time point during a 3D scanning procedure.

### Operation

The term “substantially” and “approximately” means a proportion of at least about 60%, or at least about 70% or at least about 80%, or at least about 90%, at least about 95%, at least about 97% or at least about 99% or more, or any integer between 70% and 100%.

The expression “at least one of A or B”, as used herein, is interchangeable with the expression “A and/or B” and refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The above interpretation applies for longer lists having a same format.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

1. A three-dimensional (3D) scanner for projecting an interleaved pattern, the 3D scanner comprising a set of projectors and at least one camera, wherein the set of projectors comprise:
a. a first projector for projecting a first multiline pattern onto a surface of a target object; and
b. a second projector for projecting a second multiline pattern onto the surface concurrently with the first multiline pattern to generate the interleaved pattern, wherein the second projector is positioned relative to the first projector such that:
i. a light line of the first multiline pattern is projected onto the surface between two light lines of the second multiline pattern; and
ii. a light plane projected by the first projector defining the light line of the first multiline pattern and two light planes projected by the second projector defining the two light lines of the second multiline pattern is non-intersecting throughout a depth of field (DOF) of the 3D scanner.

2. The scanner of claim 1, wherein the first projector and the second projector are mounted to the 3D scanner such that each light plane projected by the first projector and each light plane projected by the second projector are non-intersecting throughout the DOF of the 3D scanner.

3. The scanner of claim 1, wherein the first projector and the second projector are mounted to the 3D scanner such that a first origin of the first projector and a second origin of the second projector is offset by a projector offset angle.

4. The scanner of claim 3, wherein the projector offset angle is a function of at least one of: a number of projectors in the set of projectors, a first inter-beam angle between light planes projected by the first projector or a second inter-beam angle between light planes projected by the second projector.

5. The scanner of claim 4, wherein the first inter-beam angle and the second inter-beam angle are substantially the same and wherein the projector offset angle is approximately ½ of the first and second inter-beam angles.

6. The scanner of claim 4, wherein the first inter-beam angle and the second inter-beam angle are different.

7. The scanner of claim 1, wherein the light line of the first multiline pattern is projected onto the surface immediately adjacent the two light lines of the second multiline pattern.

8. The scanner of claim 1, wherein more than one light line of the first multiline pattern is projected onto the surface between the two light lines of the second multiline pattern and wherein the light line of the first multiline pattern is projected onto the surface immediately adjacent one light line of the first multiline pattern and one light line of the second multiline pattern.

9. The scanner of claim 1, wherein the set of projectors further comprise a third projector for projecting a third multiline pattern onto the surface concurrently with the first multiline pattern and the second multiline pattern to generate the interleaved pattern.

10. The scanner of claim 9, wherein the first projector, the second projector and the third projector are mounted to the 3D scanner such that a first origin of the first projector and a second origin of the second projector is offset by a first projector offset angle and a third origin of the third projector and the second origin is offset by a second projector angle.

11. The scanner of claim 10, wherein the first and second projector offset angles are functions of at least one of: a number of projectors in the set of projectors, a first inter-beam angle between light planes projected by the first projector, a second inter-beam angle between light planes projected by the second projector, or a third inter-beam angle between light planes projected by the third projector.

12. The scanner of claim 11, wherein the first inter-beam angle, the second inter-beam angle and the third inter-beam angle are substantially the same and wherein the first and second projector offset angles are both approximately ⅓ of the first, second and third inter-beam angles.

13. The scanner of claim 11, wherein the first inter-beam angle, the second inter-beam angle and the third inter-beam angle are different.

14. The scanner of claim 1, wherein the set of projectors further comprise at least one further projector for projecting at least one further multiline pattern onto the surface concurrently with the first multiline pattern and the second multiline pattern.

15. The scanner of claim 14, wherein the at least one further projector is mounted to the 3D scanner such that at least one origin of the at least one further projector is offset by a projector offset angle relative to at least one of a first origin of the first projector and a second origin of the second projector, wherein the projector offset angle is a function of at least one of: a number of projectors in the set of projectors or inter-beam angles of light planes projected by the projectors in (Original) the set of projectors.

16. The scanner of claim 1, wherein the set of projectors comprise a top set of projectors, the first projector comprises a first top projector, the second projector comprises a second top projector, and the interleaved pattern comprises a first interleaved pattern, wherein the 3D scanner further comprises a bottom set of projectors and wherein the bottom set of projectors comprises:
a. a first bottom projector for projecting a third multiline pattern onto the surface at a different time point than projection of the first multiline pattern by the first top projector and projection of the second multiline pattern by the second top projector; and
b. a second bottom projector for projecting a fourth multiline pattern onto the surface concurrently with the third multiline pattern to generate a second interleaved pattern.

17. The scanner of claim 16, wherein the top set of projectors are mounted to the 3D scanner such that a top baseline of the top set of projectors is at a top set angle relative to a scanner plane of the 3D scanner and the bottom set of projectors are mounted to the 3D scanner such that a bottom baseline of the bottom set of projectors is at a bottom set angle relative to the scanner plane.

18. The scanner of claim 17, wherein the top set angle is approximately +30°, and the bottom set angle is approximately −30°.

19. The scanner of claim 1, wherein the at least one camera is for capturing at least one image including a representation of the interleaved pattern or a portion thereof reflected from the surface when the first and second projector projects the first and second multiline patterns concurrently onto the surface.

20. The scanner of claim 19 further comprising at least one processor circuit for processing the at least one image and to generate 3D measurements for the surface based at least in part on the representation of the interleaved pattern or the portion thereof reflected from the surface.

21. A method of projecting an interleaved pattern with a three-dimensional (3D) scanner having a set of projectors and at least one camera, the method comprising:
a. projecting, with a first projector of the set of projectors, a first multiline pattern onto a surface of a target object; and
b. projecting, with a second projector of the set of projectors, a second multiline pattern onto the surface concurrently with the first multiline pattern to generate the interleaved pattern, wherein the second projector is positioned relative to the first projector such that:
i. a light line of the first multiline pattern is projected onto the surface between two light lines of the second multiline pattern; and
ii. a light plane projected by the first projector defining the light line of the first multiline pattern and two light planes projected by the second projector defining the two light lines of the second multiline pattern is non-intersecting throughout a depth of field (DOF) of the 3D scanner.

22. The method of claim 21, wherein the first projector and the second projector are mounted to the 3D scanner such that each light plane projected by the first projector and each light plane projected by the second projector are non-intersecting throughout the DOF of the 3D scanner.

23. The method of claim 21, wherein the first projector and the second projector are mounted to the 3D scanner such that a first origin of the first projector and a second origin of the second projector is offset by a projector offset angle.

24. The method of claim 23, wherein the projector offset angle is a function of at least one of: a number of projectors in the set of projectors, a first inter-beam angle between light planes projected by the first projector or a second inter-beam angle between light planes projected by the second projector.

25. The method of claim 24, wherein the first inter-beam angle and the second inter-beam angle are substantially the same and wherein the projector offset angle is approximately ½ of the first and second inter-beam angles.

26. The method of claim 24, wherein the first inter-beam angle and the second inter-beam angle are different.

27. The method of claim 21, wherein the second projector is positioned relative to the first projector such that the light line of the first multiline pattern is projected onto the surface immediately adjacent the two light lines of the second multiline pattern.

28. The method of claim 21, wherein the second projector is positioned relative to the first projector such that more than one light line of the first multiline pattern is projected onto the surface between the two light lines of the second multiline pattern and wherein the light line of the first multiline pattern is projected onto the surface immediately adjacent one light line of the first multiline pattern and one light line of the second multiline pattern.

29. The method of claim 21, further comprising projecting, with a third projector of the set of projectors, a third multiline pattern onto the surface concurrently with the first multiline pattern and the second multiline pattern to generate the interleaved pattern.

30. The method of claim 29, wherein the first projector, the second projector and the third projector are mounted to the 3D scanner such that a first origin of the first projector and a second origin of the second projector is offset by a first projector offset angle and a third origin of the third projector and the second origin is offset by a second projector angle.

31. The method of claim 30, wherein the first and second projector offset angles are functions of at least one of: a number of projectors in the set of projectors, a first inter-beam angle between light planes projected by the first projector, a second inter-beam angle between light planes projected by the second projector, or a third inter-beam angle between light planes projected by the third projector.

32. The method of claim 31, wherein the first inter-beam angle, the second inter-beam angle and the third inter-beam angle are substantially the same and wherein the first and second projector offset angles are both approximately ⅓ of the first, second and third inter-beam angles.

33. The method of claim 31, wherein the first inter-beam angle, the second inter-beam angle and the third inter-beam angle are different.

34. The method of claim 21, wherein the set of projectors further comprise at least one further projector for projecting at least one further multiline pattern onto the surface concurrently with the first multiline pattern and the second multiline pattern.

35. The method of claim 34, wherein the at least one further projector is mounted to the 3D scanner such that at least one origin of the at least one further projector is offset by a projector offset angle relative to at least one of a second origin of the second projector and a first origin of the first projector, wherein the projector offset angle is a function of at least one of: a number of projectors in the set of projectors or inter-beam angles of light planes projected by the projectors in the set of projectors.

36. The method of claim 21, wherein the set of projectors comprise a top set of projectors, the first projector comprises a first top projector, the second projector comprises a second top projector, the interleaved pattern comprises a first interleaved pattern, the 3D scanner further comprises a bottom set of projectors, and wherein the method further comprises:
a. projecting, with a first bottom projector of the bottom set of projectors, a third multiline pattern onto the surface at a different time point than projection of the first multiline pattern by the first top projector and projection of the second multiline pattern by the second top projector; and
b. projecting, with a second bottom projector of the bottom set of projectors, a fourth multiline pattern onto the surface concurrently with the third multiline pattern to generate a second interleaved pattern.

37. The method of claim 36, wherein the top set of projectors are mounted to the 3D scanner such that a top baseline of the top set of projectors is at a top set angle relative to a scanner plane of the 3D scanner and the bottom set of projectors are mounted to the 3D scanner such that a bottom baseline of the bottom set of projectors is at a bottom set angle relative to the scanner plane.

38. The method of claim 37, wherein the top set angle is approximately +30°, and the bottom set angle is approximately −30°.
